(19) United States
(12) Patent Application Publication
(10) Pub. No.: US 2026/0349635 A1
(43) Pub. Date: Nov. 5, 2026

(54) DISPLAY CONTROL METHOD, DISPLAY SYSTEM, ELECTRICAL DEVICE AND READABLE STORAGE MEDIUM

(71) Applicant: BOE TECHNOLOGY GROUP CO., LTD., Beijing (CN)

(72) Inventor: Yingjie LI, Beijing (CN)

(73) Assignee: BOE TECHNOLOGY GROUP CO., LTD., Beijing (CN)

(21) Appl. No.: 18/291,867

(22) PCT Filed: Feb. 18, 2022
(86) PCT No.: PCT/CN2022/076856

§ 371 Date: Jul. 27, 2026

(30) Foreign Application Priority Data
Oct. 29, 2021 (CN) 202111269094.9

(51) Int. Cl. G06F 3/14; G06F 3/0482; H04W 76/10

(52) U.S. Cl. CPC G06F 3/14; G06F 3/0482; H04W 76/10

(57) ABSTRACT

A display control method, a display system, an electronic device and a readable storage medium. The display control method is applied to a display system and includes the following steps: establishing, by the first device, a communication connection with the second device; sending, by the first device, application information of a first application program to the second device, wherein the first application program is an application program installed on the first operating system; displaying, by the second device, a first identifier on a display interface of the second operating system according to the application information, wherein the first identifier is an identifier corresponding to the first application program.

### CROSS-REFERENCE TO RELATED APPLICATION

The present disclosure claims priorities of the Chinese patent application No. 202111269094.9 filed on Oct. 29, 2021, which are incorporated herein by reference in their entireties.

### TECHNICAL FIELD

The present disclosure relates to the field of computer technology, in particular to a display control method, a display system, an electrical device and a readable storage medium.

### BACKGROUND

Electronic devices need to run based on the operating system. Generally, when the electronic device is running, only one operating system is running at the same time. Because some applications only support one operating system, or have a better optimization effect for one of the operating systems, therefore, users are more accustomed to utilizing a specific operating system to run some applications.

### SUMMARY

In one aspect, the present disclosure provides in some embodiments a display control method, applied to a display system, the display system includes: a first device and a second device, the first device is installed with a first operating system, and the second device is installed with a second operating system, the second device includes a display, and the second device controls the display to display a display interface of the second operating system; the method comprises the steps of: establishing, by the first device, a communication connection with the second device; sending, by the first device, application information of a first application program to the second device, wherein the first application program is an application program installed on the first operating system; displaying, by the second device, a first identifier on a display interface of the second operating system according to the application information, wherein the first identifier is an identifier corresponding to the first application program.

In some embodiments, after establishing, by the first device, a communication connection with the second device, the method further comprises: sending, by the second device, a display request of the first application program to the first device; the sending, by the first device, application information of a first application program to the second device, includes: sending, by the first device, the application information of the first application program to the second device according to the display request.

In some embodiments, the displaying, by the second device, a first identifier on a display interface of the second operating system according to the application information comprises: displaying, by the second device, a menu identifier on a first interface of the second operating system; when the second device receives an access request for the menu identifier, displaying a second interface including the first identifier.

In some embodiments, the method further includes: when the second device receives an initial access request for the menu identifier, determining whether the second device establishes communication connection with the first device, if the second device has not established communication connection with the first device, establishing, by the second device, communication connection with the first device based on the initial access request.

In some embodiments, the first interface is a functional interface of a handwriting software of the second operating system.

In some embodiments, the displaying, by the second device, a first identifier on a display interface of the second operating system according to the application information comprises: displaying at least one first identifier and at least one second identifier on the display interface of the second operating system, wherein the second identifier is an identifier corresponding to the second application program installed on the second operating system.

In some embodiments, after the displaying, by the second device, a first identifier on a display interface of the second operating system according to the application information, the method further include: receiving, by the second device, an access request for a target application identifier in the first identifier; sending, by the second device, a start request to the first device; starting, by the first device, a target application program corresponding to the target application identifier according to the start request.

In some embodiments, after starting, by the first device, a target application program according to the start request, the method further comprises: switching the display of the second device to display the display interface of the first operating system; running, by the first device, the target application program based on the first operating system, and displaying a running interface of the target application program on the display interface of the first operating system.

In some embodiments, after starting, by the first device, a target application program according to the start request, the method further comprises: generating, by the second device, an application window on the display interface of the second operating system, and the application window corresponding to at least part of an area of the display interface; running, by the first device, the target application program, and sending an application running interface of the target application program to the second device; displaying, by the second device, the application running interface in the application window.

In some embodiments, after generating, by the second device, an application window on the display interface of the second operating system, the method further comprises: receiving, by the second device, a first operation input for an area corresponding to the application window; converting, by the second device, the first operation input into a second operation input corresponding to the first device; sending, by the second device, the second operation input to the first device.

In some embodiments, after the generating, by the second device, an application window on the display interface of the second operating system, the method further comprises: receiving, by the second device, a first operation input for an area corresponding to the application window; sending, by the second device, the first operation input to the first device; converting, by the first device, the first operation input into a second operation input corresponding to the first device.

In some embodiments, the first device has a first communication module, the second device has a second communication module, the first device and the second device establishes communication connection in a first communication mode through the first communication module and the second communication module; the first device and the second device establish communication connection in a second communication mode based on a target communication network; a data transmission speed of the second communication mode is greater than a data transmission speed of the first communication mode.

In some embodiments, before the sending, by the first device, the application information of the first application program to the second device, the method further comprises: when the first device and the second device are connected through the first communication mode, sending, by the second device, network access information to the first device through the first communication mode; accessing, by the first device, the target communication network according to the network access information, wherein when the first device accesses the target communication network, the first device and the second device establish connection in the second communication mode based on the target communication network.

In some embodiments, before accessing, by the first device, the target communication network according to the network access information, the method further comprises: detecting, by the first device, whether the first application program located in the target folder in the first device changes; accessing, by the first device, the target communication network according to the network access information when the first application program located in the target folder changes.

In some embodiments, the second device includes a third communication module, the second device is in communication connection with the target communication network through the third communication module, and the network access information includes access information of the target communication network.

In some embodiments, the second device includes a third communication module, and the target communication network is provided by the second device through the third communication module

In some embodiments, the second device further comprises a fourth communication module, the fourth communication module comprises a wireless communication module and/or a network interface, and the second device establishes network connection through the wireless communication module and/or the network interface.

In some embodiments, the first communication mode is serial port communication, and the second communication mode is wireless local area network data communication.

In some embodiments, the first communication mode is serial communication, and the second communication mode is Bluetooth communication.

In some embodiments, the first communication mode is used to transmit one or more of network access information, file path information and an instruction execution result of the target communication network; the second communication mode is used to transmit one or more of file data and multimedia data.

In some embodiments, the first device and the second device are connected through a local area network, and before the first device sends the application information of the first application program to the second device, the method further includes: sending, by the second device, broadcast information to the local area network where the second device is located; sending, by the first device, response information to the second device, wherein the response information is generated according to the broadcast information, and the response information carries device information of the first device; establishing, by the second device, communication connection with the first device according to the response information.

In some embodiments, the establishing, by the second device, communication connection with the first device according to the response information comprises: adding, by the second device, the first device to a device list according to the response information; obtaining, by the second device, a selection instruction for the first device; establishing, by the second device, communication connection with the first device according to the selection instruction.

In some embodiments, the display system further includes a management server, and before the first device sends the application information of the first application program to the second device, the method further includes: sending, by the second device, a connection request to the management server; sending, by the management server, the device information of the first device to the second device according to the connection request, wherein the first device is pre-registered in the management server; establishing, by the second device, communication connection with the first device according to the device information.

In some embodiments, the sending, by the first device, the application information of the first application program to the second device, comprises: obtaining, by the first device, the application information of the first application program located in the target folder; sending, by the first device, the application information to the second device; wherein, the target folder is a folder with a preset path in the first device.

In some embodiments, the target folder is a desktop folder of the first device and/or a launch bar folder of the first device.

In some embodiments, before the obtaining, by the first device, the application information of the first application program located in the target folder, the method further comprises: retrieving, by the first device, one or more of an application program of a preset program type, a file of a preset file type, and an application program with a preset name in the target folder as the first application program.

In some embodiments, the first operating system is a Windows operating system, and the second operating system is an Android system.

In some embodiments, the method further comprises: sending, by the second device, a sharing request to the first device; receiving, by the second device, sharing information returned by the first device according to the sharing request, wherein the sharing information includes a folder path and a sharing protocol of the shared folder, the shared folder is a folder in the first device; accessing, by the second device, the shared folder according to the sharing protocol and the folder path.

In some embodiments, the method further comprises: generating, by the second device, a shared space; sending, by the second device, space information of the shared space to the first device, wherein the space information includes a folder path and a sharing protocol of the shared space; sending, by the first device, the shared file to the second device based on the sharing protocol and the folder path.

In a second aspect, a display control method is applied to a first device in a display system, wherein the display system includes a first device and a second device, the first device is installed with a first operating system, and the second device is installed with a second operating system, the second device includes a display, and the second device controls the display to display a display interface of the second operating system; the method comprises the steps of: establishing communication connection with the second device, sending the application information of the first application program to the second device, so that the second device displays a first identifier on the display interface of the second operating system according to the application information, wherein the first identifier is an identifier corresponding to the first application program, and the first application program is an application program installed on the first operating system.

In a third aspect, a display control method is applied to a second device in a display system, wherein the display system includes a first device and a second device, the first device is installed with a first operating system, and the second device is installed with a second operating system, the second device includes a display, and the second device controls the display to display a display interface of the second operating system; the method comprises the steps of: establishing communication connection with the first device; receiving application information of a first application program sent by the first device, wherein the first application program is an application program installed on the first operating system; displaying a first identifier on the display interface of the second operating system according to the application information, wherein the first identifier is an identifier corresponding to the first application program.

In a fourth aspect, a display system, comprising a first device and a second device, wherein the first device is installed with a first operating system, the second device is installed with a second operating system, the first device and the second device are in communication connection, the second device includes a display, and the second device controls the display to display the display interface of the second operating system; the first device and the second device are configured to: establish communication connection between the first device and the second device; the first device is configured to: send application information of the first application program to the second device, wherein the first application program is an application program installed on the first operating system; the second device is further configured to: display a first identifier on the display interface of the second operating system according to the application information, wherein the first identifier is an identifier corresponding to the first operating system.

In some embodiments, the second device is configured to: send a display request of the first application program to the first device; the first device is configured to: send the application information of the first application program to the second device according to the display request.

In some embodiments, the first device is an external computer module, the second device is an intelligent interactive tablet, the intelligent interactive tablet includes a communication interface, and the external computer module is in communication connection with the intelligent interactive tablet through the communication interface.

In some embodiments, the external computer module is an OPS module including an OPS interface.

In some embodiments, when the second device displays a first identifier on the display interface of the second operating system according to the application information, the second device specifically configured to: display a menu identifier on the first interface of the second operating system; when an access request for the menu identifier is received, display a second interface including the first identifier.

In some embodiments, the second device is configured to: when an initial access request for the menu identifier is received, determine whether the second device establishes communication connection with the first device, in the case that the second device has not established communication connection with the first device, establish communication connection with the first device based on the initial access request.

In some embodiments, the first interface is a functional interface of a handwriting software of the second operating system.

In some embodiments, when the second device displays the first identifier on the display interface of the second operating system according to the application information, the second device is specifically configured to: display at least one first identifier and at least one second identifier on the display interface of the second operating system, wherein the second identifier is an identifier corresponding to a second application program installed on the second operating system.

In some embodiments, the second device is further configured to: receive an access request for a target application identifier in the first identifier; send a start request to the first device; the first device is further configured to: start a target application program corresponding to the target application identifier according to the start request.

In some embodiments, the second device is further configured to: switch the display to display the display interface of the first operating system; the first device is configured to: run the target application program based on the first operating system, and display a running interface of the target application program on the display interface of the first operating system.

In some embodiments, the second device is further configured to: generate an application window on the display interface of the second operating system, and the application window corresponding to at least part of an area of the display interface; the first device is further configured to: run the target application program, and send an application running interface of the target application program to the second device; the second device is further configured to: display the application running interface in the application window.

In some embodiments, the second device is further configured to: receive a first operation input for an area corresponding to the application window; convert the first operation input into a second operation input corresponding to the first device; send the second operation input to the first device.

In some embodiments, the second device is further configured to: receive a first operation input for an area corresponding to the application window; send the first operation input to the first device; convert the first operation input into a second operation input corresponding to the first device.

In some embodiments, the first device has a first communication module, the second device has a second communication module, and the first device and the second device establish communication connection in the first communication mode through the first communication module and the second communication module; the first device and the second device establish communication connection in a second communication mode based on a target communication network; a data transmission speed of the second communication mode is greater than a data transmission speed of the first communication mode.

In some embodiments, the second device is further configured to: in the case that the first device and the second device are connected through the first communication mode, send network access information to the first device through the first communication mode; the first device is configured to: access a target communication network according to the network access information, wherein when the first device accesses the target communication network, the first device and the second device establish connection in the second communication mode based on the target communication network.

In some embodiments, the first device is configured to: detect whether the first application program located in the target folder in the first device changes; access the target communication network according to the network access information when the first application program located in the target folder changes.

In some embodiments, the second device includes a third communication module, the second device is in communication connection with the target communication network through the third communication module, and the network access information includes access information of the target communication network.

In some embodiments, the second device includes a third communication module, and the target communication network is provided by the second device through the third communication module.

In some embodiments, the second device further includes a fourth communication module, the fourth communication module includes a wireless communication module and/or a network interface, the second device establishes network connection through the wireless communication module and/or the network interface.

In some embodiments, the first communication mode is serial port communication, and the second communication mode is wireless local area network data communication.

In some embodiments, the first communication mode is serial communication, and the second communication mode is Bluetooth communication.

In some embodiments, the first communication mode is used to transmit one or more of network access information, file path information and an instruction execution result of the target communication network; the second communication mode is used to transmit one or more of file data and multimedia data.

In some embodiments, the first device and the second device are connected through a local area network; the second device is further configured to: send broadcast information to the local area network where it is located; the first device is further configured to: send response information to the second device, wherein the response information is generated according to the broadcast information, and the response information carries device information of the first device; the second device is further configured to: establish communication connection with the first device according to the response information.

In some embodiments, when the second device establishes communication connection with the first device according to the response information, the second device is specifically configured to: add the first device to a device list according to the response information; obtain a selection instruction for the first device; establish communication connection with the first device according to the selection instruction.

In some embodiments, the display system further comprises a management server; the second device is further configured to: send a connection request to the management server; the management server is configured to: send the device information of the first device to the second device according to the connection request, wherein the first device is pre-registered in the management server; the second device is further configured to: establish communication connection with the first device according to the device information.

In some embodiments, when the first device sends the application information of the first application program to the second device, the first device is specifically configured to: obtain the application information of the first application program located in the target folder; send the application information to the second device; wherein the target folder is a folder with a preset path in the first device.

In some embodiments, the target folder is a desktop folder of the first device and/or a launch bar folder of the first device.

In some embodiments, the first device is configured to: retrieve one or more of an application program of a preset program type, a file of a preset file type, and an application program with a preset name in the target folder as the first application program.

In some embodiments, the first operating system is a Windows operating system, and the second operating system is an Android system.

In some embodiments, the second device is further configured to: send a sharing request to the first device; receive sharing information returned by the first device according to the sharing request, the sharing information includes a folder path and a sharing protocol of the shared folder, wherein the shared folder is a folder in the first device; access the shared folder according to the sharing protocol and the folder path.

In some embodiments, the second device is further configured to: generate a shared space; send space information of the shared space to the first device, wherein the space information includes a folder path and a sharing protocol of the shared space; the first device is further configured to: send the shared file to the second device based on the sharing protocol and the folder path.

In a fifth aspect, an electronic device is a second device in a display system, the display system includes a first device and the second device, the first device is installed with a first operating system, and the second device is installed with a second operating system, the second device includes a display, and the second device controls the display to display a display interface of the second operating system; the second device is configured to: establish communication connection with the first device; receive application information of a first application program sent by the first device, wherein the first application program is an application program installed on the first operating system; display a first identifier on the display interface of the second operating system according to the application information of the first application program, wherein the first identifier is an identifier corresponding to the first application program.

In some embodiments, the first device is an external computer module, the second device is an intelligent interactive tablet, the intelligent interactive tablet includes a communication interface, and the external computer module is in communication connection with the intelligent interactive tablet through the communication interface.

In some embodiments, the external computer module is an OPS module including an OPS interface.

In some embodiments, when the second device displays the first identifier on the display interface of the second operating system according to the application information, the second device is specifically configured to: display a menu identifier on the first interface of the second operating system; when an access request for the menu identifier is received, display a second interface including the first identifier.

In some embodiments, the first interface is a functional interface of a handwriting software of the second operating system.

In some embodiments, when the second device displays the first identifier on the display interface of the second operating system according to the application information, the second device is specifically configured to: display at least one first identifier and at least one second identifier on the display interface of the second operating system, wherein the second identifier is an identifier corresponding to a second application program installed on the second operating system.

In a sixth aspect, an electronic device, includes: a memory, a processor, and a program stored on the memory and executed by the processor; the processor is used to read the program in the memory to implement the steps of the display control method.

In a seventh aspect, a readable storage medium for storing a program, wherein the program is executed by a processor to implement the steps of the display control method.

### BRIEF DESCRIPTION OF THE DRAWINGS

In order to more clearly illustrate the technical solutions of the embodiments of the present disclosure, the following will briefly introduce the accompanying drawings that need to be used in the description of the embodiments of the present disclosure. Obviously, the accompanying drawings in the following description are only some embodiments of the present disclosure. For those skilled in the art, other drawings can also be obtained based on these drawings without any creative effort.

FIG. 1 is a connection scene diagram of a first device and a second device according to an embodiment of the present disclosure;

FIG. 2 is a schematic flowchart of a display control method according to an embodiment of the present disclosure;

FIG. 3 is a schematic flowchart of launching a target application program according to an embodiment of the present disclosure;

FIG. 4 is a schematic diagram of a display interface of a second device according to an embodiment of the present disclosure;

FIG. 5 is a schematic flowchart of implementing file sharing according to an embodiment of the present disclosure;

FIG. 6 is a schematic structural diagram of a first device and a second device according to an embodiment of the present disclosure

FIG. 7 is a schematic structural diagram of a first device and a second device according to an embodiment of the present disclosure;

FIG. 8 is a schematic structural diagram of an electronic device according to an embodiment of the present disclosure.

### DETAILED DESCRIPTION

In order to further explain the display substrate and display device provided by the embodiments of the present disclosure, the following will be described in detail with reference to the drawings of the present disclosure.

The following will clearly and completely describe the technical solutions in the embodiments of the present disclosure with reference to the accompanying drawings. Apparently, the described embodiments are part of the embodiments of the present disclosure, not all of them. Based on the embodiments in the present disclosure, all other embodiments obtained by a person skilled in the art without creative efforts fall within the protection scope of the present disclosure.

The terms “first”, “second” and the like in the embodiments of the present disclosure are used to distinguish similar objects, and are not necessarily used to describe a specific sequence. Furthermore, the terms “comprising” and “including”, as well as any variations thereof, are intended to cover a non-exclusive inclusion, for example, a process, method, system, product or device comprising a sequence of steps or elements is not necessarily limited to the expressly listed, instead, may include other steps or elements not explicitly listed or inherent to the process, method, product or device. In addition, the use of “and/or” in this disclosure means at least one of the connected objects, such as A and/or B and/or C, means that A alone, B alone, C alone, both A and B, both B and C, both A and C, and A, B and C, there are 7 situations in total.

In some aspects of the present disclosure, a display control method is provided.

In some of the embodiments, the display control method is applied to a display system.

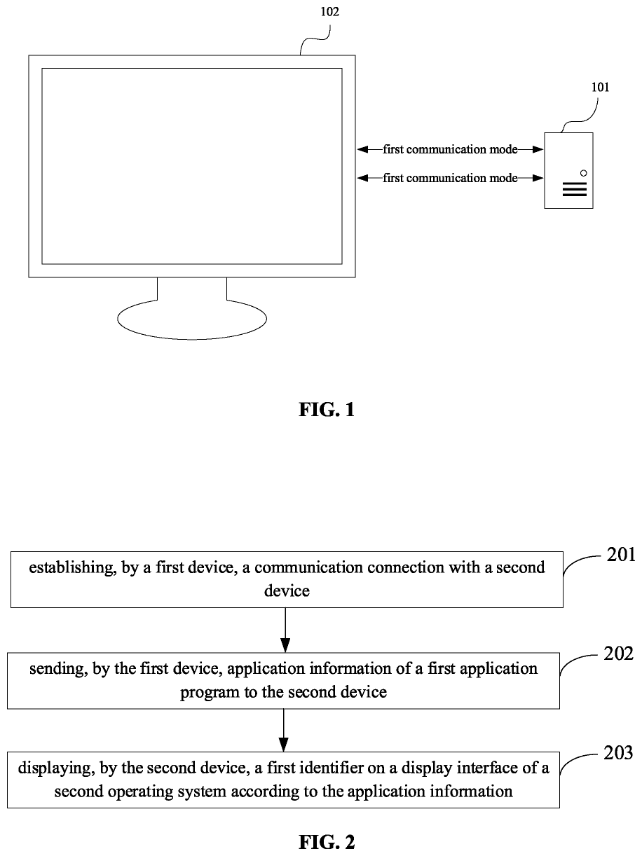

As shown in FIG. 1, in one embodiment, the display system includes a first device 101 and a second device 102, the first device 101 is installed with a first operating system, the second device 102 is installed with a second operating system, the first device 101 is in communication with a second device 102, the second device 102 includes a display, and the second device 102 can control the display to display a display interface of the second operating system.

In one embodiment, the first device 101 is an external computer module. In some embodiments, the external computer module is an Open Pluggable Specification (OPS, a computing module plug-in format) that includes an OPS interface, in this embodiment, only the external computer module is an OPS module for exemplary illustration, and the second device 102 is an intelligent interactive tablet.

It can be understood that, in this embodiment, only the first device 101 is used as an OPS module, and the second device 102 is an intelligent interactive tablet for exemplary illustration. The first device 101 and the second device 102 can also be other devices, which are not limited here.

Intelligent interactive tablet, also known as an intelligent tablet or a conference tablet, is a intelligent device that supports human-computer interaction functions such as touch control. The intelligent interactive tablet usually supports multiple operation signal sources. For example, it can run the operating system installed by itself or run based on a signal from an external device.

The display of the intelligent interactive tablet only supports displaying the interface of one operating system at the same time, for example, it can be Android (an operating system), Windows (an operating system) system, Linux (an operating system), Kirin (an operating system), UOS (an operating system) and other different operating systems. In order to improve the adaptability to different scenarios, it can provide multi-system support for the intelligent interactive tablet.

Exemplarily, the intelligent interactive tablet serving as the second device 102 in this embodiment runs based on the Android system, for example, it may be an Android system customized according to needs, so as to provide better user experience. In order to provide better software services, in this embodiment, it is also necessary to provide Windows system support for the intelligent interactive tablet. In this embodiment, the OPS module is used as the first device 101, and the Windows system runs on the OPS module. Obviously, other operating systems can also be run on the OPS module as required.

In some embodiments, the OPS module specifically includes a control chip SOC, a memory, a memory, a power supply, a power management system, a physical interface transceiver (PHY), a Universal Serial Bus (USB), multi-port transponder (UHB), multiple USB interfaces, wireless communication modules (such as Wireless Fidelity (WiFi) module) and video interfaces (such as High Definition Multimedia Interface (HDMI), DisplayPort (DP, digital video interface standard), Digital Visual Interface (DVI), Video Graphics Array (VGA)), etc. Apparently, the interface can be set as required, for example, a Universal Asynchronous Receiver/Transmitter (UART) interface, an audio interface, etc. can be added, which are not further limited here.

The OPS module can communicate with the intelligent interactive tablet through a connector. The connector can be an 80pin connector. The connector is integrated with power signals, USB signals, video signals, etc. During implementation, the OPS module can be directly plugged into the intelligent interactive tablet through the connector, so as to provide power for the OPS module through the intelligent interactive tablet, and at the same time, data transmission is implemented based on USB signals and video signals.

It can be understood that the operating systems running on the first device 101 and the second device 102 can also be changed and adjusted as needed, which is not further limited in this embodiment.

In the related art, if the intelligent interactive tablet needs to run the software in the OPS module during operation, the operator needs to disconnect the video signal provided by the second operating system to the display of the second device 102, and then connect the video signal of the OPS module to the display of the second device 102. Further, the software in the OPS module is started.

As shown in FIG. 2, in some embodiments, the display control method includes the following steps:
Step 201: establishing, by a first device, a communication connection with a second device;
Step 202: sending, by the first device, application information of a first application program to the second device, wherein the first application program is an application program installed on a first operating system;
Step 203: displaying, by the second device, a first identifier on a display interface of a second operating system according to the application information.

In this embodiment, the first device and the second device first need to establish a communication connection. Next, the first device sends application information of the application program installed on the first operating system to the second device.

In some embodiments, the application information is sent according to a display request of the second device.

Specifically, in some embodiments, in the embodiment, after step 202, the method further includes:
Sending, by the second device, a display request of the first application program to the first device;
The sending, by the first device, the application information of the first application program to the second device, includes:
Sending, by the first device, the application information of the first application program to the second device according to the display request.

In this embodiment, the second device first sends a display request to the first device to obtain information about the first application program in the first device. After receiving the display request sent by the second device, the first device sends the application information of the first application program to the second device. After receiving the application information, the second device displays the first identifier on the display interface of the second operating system installed on the second device.

In this embodiment, the first application program may be an application program installed on the first device, for example, application programs such as chatting, video conferencing, browser, etc. installed in the windows system, in addition, the first application program may also include folders, a file with a certain format (such as a word file) and so on.

In this embodiment, the first identifier may be the first application identifier corresponding to the first application program, and the first identifier may also be a first folder identifier corresponding to a folder where the first application program is located.

In this embodiment, the first application identifier can be displayed in different ways. For example, an icon of the first application program can be directly displayed as the first application identifier, or a name of the first application program can be displayed as the first application identifier.

In this embodiment, the application information may specifically include information related to the first application such as the name, icon, startup parameters, application type, and link address of the first application, so that the second device can display the first identifier according to the application information sent by the first device.

In the embodiment, when the second operating system is running, the first identifier on the first device can be displayed on the display interface of the second operating system, and it is not necessary to switch to the first operating system to know the related information of the first application program, which improves the user's operation convenience in the process of using the first device and the second device.

In this embodiment, the identifier corresponding to the first application program can be used in different ways to improve the convenience of use.

In some embodiments, the above step 203 includes:
Displaying, by the second device, a menu identifier on a first interface of the second operating system;
When the second device receives an access request for the menu identifier, displaying a second interface including the first identifier.

In this embodiment, a menu identifier can be displayed first, and the user can access the menu identifier in different ways, for example, the menu identifier can be accessed by clicking, voice control, mouse control, touchpad control and other ways.

When the user accesses the menu identifier, a second interface including the first identifier is displayed.

Exemplarily, in this embodiment, a folder can be opened as the second interface, and the first identifier can be displayed in the folder; as another example, an application list can also be expanded as the second interface, and the first identifier can be displayed in the application list. In addition, a submenu of the menu identifier can also be set, and the submenu can be used as the second interface for displaying the first identifier.

In some embodiments, the first interface is a functional interface of the handwriting software of the second operating system, and the first identifier corresponding to the first application program can be displayed in the form of an icon or a list on the functional interface.

In some embodiments, the handwriting software is specifically used as a handwriting board to provide handwriting functions during the meeting. In this way, the handwriting software is equivalent to a “conference whiteboard”. When using it, participants can write content on the handwriting interface of the handwriting software to show to the participants.

The first interface is set as the functional interface of the handwriting software, so that when the first application program needs to be used, the second interface can be conveniently and quickly expanded based on the functional interface. For example, an icon on the functional interface of the handwriting software is used as the menu identifier, user clicks the menu identifier to open the second interface with the first identifier, the second interface and the first interface may have partly the same content, for example, only a sub-window in a part of region of the first interface is opened to display the first identifier, and further select the first identifier to improve the convenience of operation.

In some embodiments, the method also includes:
When the second device receives an initial access request for the menu identifier, determining whether the second device establishes communication connection with the first device,
If the second device has not established communication connection with the first device, establishing, by the second device, communication connection with the first device based on the initial access request.

The first device is the OPS module, and the second device is an intelligent interactive tablet. When the menu identifier is clicked on the second device for the first time to generate an initial access request for the menu identifier, it is first detected whether the first device establishes communication connection to the second device. If no communication connection has been established, a communication connection between the first device and the second device needs to be established.

Further, in some embodiments, the first device may be in a standby or power-off state, and when the menu identifier is clicked, the first device can be woken up or controlled to start up, so as to establish communication connection between the first device and the second device.

During implementation, the first device can be woken up or controlled to be turned on, or a prompt window can pop up for the user to select whether to control the wakeup of the first device or control the first device to be turned on in the prompt window.

It should be noted that the above-mentioned initial access request refers to a request before the second device establishes a communication connection with the first device, and the above-mentioned communication connection does not refer to a connection between physical interfaces, but a connection of electrical signals. In actual use of the product, the actual ops module is always physically connected to the intelligent interactive tablet, but when the ops module is not turned on, there is no electrical signal connection therebetween, so the above initial access request refers to access request before establishing electrical signal connection. In addition, the initial access request does not specifically refer to the “only one” access request. It is possible that the intelligent interactive tablet will perform the initial access request, and may perform multiple initial access requests each time it is turned on, it may be due to equipment failure or user operation is not completely finished, multiple initial access requests may be required, and the initial access request can be understood as an access request for establishing a communication connection between the first device and the second device.

In some embodiments, the above step 203 includes:
Displaying at least one first identifier and at least one second identifier on a display interface of the second operating system, wherein the second identifier is an identifier corresponding to a second application program installed on the second operating system.

In some embodiments, the first identifier and the second identifier can also be displayed in the same interface, for example, the first identifier and the second identifier can be displayed in the same folder. The styles of the first identifier and the second identifier may be the same or different. For example, a specific symbol may be added to the first identifier to indicate that the identifier is the first identifier on the first device.

By displaying the first identifier and the second identifier on the same interface, it is convenient for the user to fully understand the application programs that can be used, and the convenience of use is improved.

In some embodiments, after the second device displays the first identifier on the display interface of the second operating system according to the application information, the method further includes:
Receiving, by the second device, an access request for a target application identifier in the first identifier;
Sending, by the second device, a start request to the first device;
Stating, by the first device, a target application program corresponding to the target application identifier according to the start request.

In this embodiment, when the corresponding first application program needs to be run according to the selection of the first identifier, the target application is run by the first device based on the first operating system.

It can be understood that based on the start request, the second device can directly start the first device to run the target application program installed in the first operating system. During use, it is not necessary for the operator to manually switch the operating system, the target application program in the first operating system can be started and the convenience of use is improved.

In some embodiments, after the first device starts the target application according to the start request, the method further includes:
Switching the display of the second device to display the display interface of the first operating system;
Running, by the first device, the target application program based on the first operating system, and displaying a running interface of the target application program on a display interface of the first operating system.

In this embodiment, when starting the first application program, the display interface displayed on the display of the second device can be switched to display the display interface of the first operating system, and the target application program can be run on the display interface of the first operating system. The running interface of the target application program may be displayed on the display interface of the second operating system.

Specifically, in this embodiment, the video signal provided by the second operating system to the display can be disconnected, and then the display is controlled to access the video signal of the first operating system. In this way, the display interface of the target application program can be run in the first operating system and can be displayed on the display.

In addition, an application window may also be established on the display interface of the second operating system, and the display interface of the target application program is displayed in the application window.

In some embodiments, after the first device starts the target application according to the start request, the method further includes:
Generating, by the second device, an application window on the display interface of the second operating system, and the application window corresponding to at least part area of the display interface;
Running, by the first device, the target application program, and sending an application running interface of the target application program to the second device;
Displaying, by the second device, the application running interface in the application window.

As shown in FIG. 4, in this embodiment, it can be understood that a certain area is divided on the display interface of the second operating system as an application window, and the display interface of the first operating system is displayed on the application window.

The implementation of the application window can be based on the widget provided by the Android system, or based on the window Manager function provided by the Android system, a floating window can be established on the display interface of the second operating system as the application window.

Exemplarily, it may be to display the target application interface running based on the first operating system. In this way, it is equivalent to displaying the running content of two operating systems on the same display interface. At this time, the display interface of the first operating system and the display interface of the second operating system may coexist, and the first operating system and the second operating system may run simultaneously.

The application window can be understood as a player running in the floating window or widget mode on the display interface of the second operating system, and the video signal input by the OPS module is converted through Mobile Industry Processor Interface (MIPI) to realize the video stream of the camera, the video stream is then played in the player, so that the running interface of the first operating system can be played in the form of video. The size and position of the application window can be fixed, or adjustment controls can be set to adjust the size, position, etc. of the application window, which will not be further limited here.

During implementation, it can be set to start the target application program by default using the application window or automatically switching the operating system. It is also possible to set different control methods to correspond to different startup methods. For example, it can be set to double-click a certain first application identifier to display the display interface of the corresponding first application program in the application window, or press a certain first application identifier for a long time, to start the corresponding first application in the mode of switching the operating system. In this embodiment, the specific control method is not further limited.

In some embodiments, after the second device generates an application window on the display interface of the second operating system, the method further includes:
Receiving, by the second device, a first operation input for an area corresponding to the application window;
Converting, by the second device, the first operation input into a second operation input corresponding to the first device;
Sending, by the second device, the second operation input to the first device.

In some other embodiments, after the second device generates an application window on the display interface of the second operating system, the method further includes:
Receiving, by the second device, a first operation input for an area corresponding to the application window;
Sending, by the second device, the first operation input to the first device;
Converting, by the first device, the first operation input into a second operation input corresponding to the first device.

Operating instructions may differ in different operating systems. Exemplarily, in the Android system, if the operation options of an application is to be opened, it is usually realized by pressing the icon of the application for a long time, while in the Windows system, it is realized by right-clicking the mouse; if an application program is to be opened, in the Android system, it is usually realized by single-click, while in Windows, it is realized by single-click with the left button of the mouse.

It can be seen that, in different operating systems, specific operation inputs corresponding to the same operation are different.

In this embodiment, if it is detected that the first operation input is for the area of the application window, that is, for the target application program running in the first operating system, then the first operation input is converted into the second operation input matched with the first operating system, the second operation input is sent to the first operating system.

The conversion process can be performed in the first device or in the second device. In other words, in this embodiment, after receiving the first operation input, the second device may convert the first operation input into a second operation input that matches the first device and then send it to the first device, or the first operation input is directly sent to the first device, and then the first device converts the first operation input into a second operation input matching with the first operation input.

In this way, in this embodiment, it is possible to operate in the second operating system according to the operating habits corresponding to the second operating system, that is, to control the first device to perform corresponding operating tasks, which simplifies the operation process and improves user experience.

In this embodiment, the first device and the second device may be controlled in different ways to establish a communication connection.

In some embodiments, the first device has a first communication module, the second device has a second communication module, and the first device and the second device establish a connection in the first communication mode through the first communication module and the second communication module; the first device and the second device establish a connection in the second communication mode based on the target communication network; the data transmission speed in the second communication mode is greater than the data transmission speed in the first communication mode.

In some embodiments, the first device and the second device may be controlled to establish a communication connection in the following modes:
When the first device and the second device are connected through a first communication mode, the second device sends network access information to the first device through the first communication mode;
The first device accesses the target communication network according to the network access information, wherein when the first device accesses the target communication network, the first device and the second device establish a connection in the second communication mode based on the target communication network.

In this embodiment, the first device and the second device perform data transmission through multiplex communication, so as to improve the convenience and speed of data transmission.

In this embodiment, the first device has a first communication module, the second device has a second communication module, and the first device and the second device establish a connection in the first communication mode through the first communication module and the second communication module. Specifically, the first device and the second device are first connected through the first communication mode. The first communication mode can be selected to implement a relatively simple connection mode. In some embodiments, the first communication module and the second communication module are serial ports that match to each other, and the first communication mode can be a serial port connection. The serial port refers to an expansion interface using a serial communication mode. The communication line of the serial port can establish a connection by using only a pair of transmission lines, which is relatively simple. The serial port connection can be realized based on the above-mentioned UART interface. In this way, the communication connection between the first device and the second device can be realized directly through the physical data line.

In some embodiments, before the first device accesses the target communication network according to the network access information, the method further includes:
Detecting, by the first device, whether the first application program located in the target folder in the first device changes;
Accessing, by the first device, the target communication network according to the network access information when the first application program located in the target folder changes.

In this embodiment, the first device may determine whether to establish a communication connection in the second communication mode with the second device as required. In some embodiments, only when the application program installed in the first device changes or it is necessary to update the relevant information of the first application program that can be used by the second device, the first device establishes the communication connection with the second device in the second communication mode.

Specifically, the first device detects whether the first application program in the target folder changes, specifically, by detecting whether the application list storing the first application program changes, or by detecting whether the application program in the target folder changes, and when the first application program in the target folder changes, the first device accesses the target communication network according to the network access information sent by the second device, so as to establish a communication connection with the second device in the second communication mode.

In some embodiments, the first communication module and the second communication module can also choose other hardware data interfaces, which can conveniently and quickly establish a connection in the first communication mode by means of plugging and unplugging.

After the first device and the second device are connected through the first communication mode, the second device sends network access information to the first device.

It can be understood that some functions of the first device and the second device need to be realized based on the network access function, the second device itself has a display, and due to the nature of the second device itself, the second device can relatively conveniently access to the network through the wireless access point, the network can be a local area network or a wide area network, such as the Internet.

In some embodiments, the second device includes a third communication module, the second device is communicatively connected to the target communication network through the third communication module, and the network access information includes network access information of the target communication network.

The third communication module may be a wifi module. Specifically, in this embodiment, the second device is provided with a wifi module, and accesses the target communication network through the wifi module. Here, the target communication network may be provided by a wireless access point such as a router or a gateway.

In some embodiments, the network access information may specifically include network access information such as the name of the wireless access point, an encryption method, a key, and a password. Based on the network access information, the first device can automatically access the wireless access point based on the network access information, so as to control the first device to access the target communication network and realize network connection. In this way, the first device and the second device can access the target communication network provided by the same wireless access point.

In some embodiments, the second device includes a third communication module, and the target communication network is provided by the second device through the third communication module.

In this embodiment, a wifi module is set on the second device, however, the wifi module is not used to enable the second device to realize network connection, but is used for network sharing. It can be understood that the second device realizes the network connection through other means, and further, establishes a wireless access point based on the wifi module, and the first device accesses the wireless access point established by the wifi module, thereby realizing the network connection.

Specifically, in some embodiments, the second device further includes a fourth communication module, the fourth communication module includes a wireless communication module and/or a network interface. That is to say, the fourth communication module may be a wireless communication module, such as a wifi module, or a wired communication module, such as a network interface that needs to be connected to a communication line.

For example, the network interface may be a network cable interface, the second device can be connected with a network cable to realize network connection. Further, the second device establishes a wireless hotspot through the wifi module to provide network sharing, and the first device accesses the wireless hotspot to realize network connection.

In another embodiment, it can be understood that the second device is provided with two wifi modules, wherein one wifi module is used to realize network connection, the other wifi module is used to establish a wireless hotspot, and the first device establishes a communication connection with the second device through a wireless hotspot established by the wifi module, so that the first device can establish a network connection with the second device through the wifi module for establishing the wireless hotspot, to realize high-speed network data communication between the first device and the second device, and also enable the first device indirectly to implement network access through the second device.

It can be understood that, in this embodiment, for the hardware structure and required software support of the wifi module, reference may be made to related art, and the wifi module itself is not further limited here.

As shown in FIG. 1, in this embodiment, the two-way communication between the first device and the second device can also be realized in other ways. Exemplarily, in some embodiments, the first communication mode is serial port communication. The second communication mode is wireless local area network (WLAN) data communication, specifically, it may be a wifi network; in some other embodiments, the first communication mode is serial port communication, and the second communication mode is Bluetooth communication.

Exemplarily, the second device can transmit Bluetooth pairing information to the first device through the first communication mode, the first device and the second device are equipped with Bluetooth modules, and the first device and the second device can use the Bluetooth module to establish a Bluetooth connection based on the Bluetooth pairing information.

In some embodiments, the data transmission speed of the second communication mode is greater than the data transmission speed of the first communication mode. The first communication mode is used to transmit one or more items of network access information, file path information and instruction execution results of the target communication network. Wherein, the file path information may include path information of files shared between the first device and the second device.

The second communication mode is used to transmit one or more items of file data and multimedia data.

In this embodiment, the communication connection established based on the first communication mode is more convenient. For example, when it is based on a serial port connection, it can be directly realized by plugging in the hardware structure. Exemplarily, the OPS module and the intelligent interactive UART interface, etc. The process is simpler. Further, based on the first communication mode, the first device and the second device can establish a second communication mode with faster data transmission speed. In this way, based on the second communication mode, various large files such as files and multimedia data (such as pictures and videos) can be transmitted faster.

In the technical solution of this embodiment, the data transmission speed and convenience are improved through the communication mode of two-way communication.

In some embodiments, the first device and the second device are located in the same local area network and are connected through a local area network, and before the first device sends the application information of the first application program to the second device, the method further includes:
Sending, by the second device, broadcast information to the local area network where the second device is located;
Sending, by the first device, response information to the second device, wherein the response information is generated according to the broadcast information, and the response information carries device information of the first device;
Establishing, by the second device, a communication connection with the first device according to the response information.

It can be understood that in this embodiment, the local area network refers to a regional network established in a local area, the distribution area of the local area network is limited, the data transmission speed inside the local area network is faster, the performance is more stable, the framework is simple, and it has a certain degree of closure. The second device may broadcast a specific message within the local area network where it is located. Exemplarily, the above broadcast information may be broadcast in a User Datagram Protocol (UDP) communication mode. The first device and the second device may access the same local area network in different ways such as the wired or wireless ways.

In some embodiments, the second device establishes a communication connection with the first device according to the response information, including:
adding, by the second device, the first device to a device list according to the response information;
obtaining, by the second device, a selection instruction for the first device;
establishing, by the second device, a communication connection with the first device according to the selection instruction.

In this embodiment, the first device and the second device can be two devices in the local area network. During implementation, the second device sends broadcast information, and multiple devices that receive the broadcast information can return response information, and the second device can add each device that returns the response information to the device list. Further, the first device among them is confirmed according to the user's selection, and a communication connection with the first device is established according to the device information carried in the response information returned by the first device to realize interaction between the first device and the second device and service sharing of applications, files, etc.

In some other embodiments, the first device and the second device may also establish a communication connection based on a wide area network, for example, the Internet.

In some embodiments, the display system further includes a management server, and before the first device sends the application information of the first application to the second device, the method further includes:
Sending, by the second device, a connection request to the management server;
Sending, by the management server, the device information of the first device to the second device according to the connection request, wherein the first device is pre-registered in the management server;
Establishing, by the second device, a communication connection with the first device according to the device information.

In this embodiment, each device that can provide services is first registered in the management server. When the second device needs to establish a communication connection with the first device, the first device can be selected from the list of registered devices provided by the management server, and further establishes the communication connection with the first device based on the relevant information of the first device carried in the registration information.

It can be understood that when the first device and the second device are connected through a local area network or a wide area network, all interactive data such as command messages, file data, and instruction execution results between the first device and the second device are transmitted through the local area network or the wide area network.

In some embodiments, the first device sends the application information of the first application to the second device, including:
Obtaining, by the first device, the application information of the first application program located in the target folder;
Sending, by the first device, the application information to the second device;
In this embodiment, the application program in the first device that the second device can invoke may be all application programs or some application programs. For example, the second device may access the register table information of the first device to invoke all application programs on the first device.

In some embodiments, in order to improve the convenience of device interaction, a specific target folder is set, and the second device can only call the application program in the target folder. The target folder may also be a folder with a preset path.

In some embodiments, the target folder may specifically be a desktop folder of the first device or a launch bar folder of the first device. In addition, it may also be a folder with a preset path such as a folder named a shared folder located on the desktop, so that the application sharing service provided by the first device can be controlled more conveniently.

In some embodiments, before the first device obtains the application information of the first application program located in the target folder, the method further includes:
Retrieving, by the first device, one or more of an application program of a preset program type, a file of a preset file type, and an application program with a preset name in the target folder as the first application program.

In this embodiment, after the target folder is determined, the first application program in the target folder is further determined. In this embodiment, one or more of an application program of a preset program type, a file of a preset file type, and an application program with a preset name are retrieved in the target folder as the first application program.

Exemplarily, in the case that the first device is an OPS module installed with the windows system, an application program with a preset name and an extension of “.exe” in the target folder may be retrieved as the first application program, or the application program with the preset program type of “executable application” or “application program” can be retrieved as the first application program, or a file with file type of “shortcut” or “shortcut launch method” can also be retrieved as the first application program.

In this embodiment, in order to improve the convenience of interaction between the first device and the second device, a file sharing function is also provided.

In some embodiments, the file sharing function may be provided based on the first device.

In some embodiments, the method also includes:
Sending, by the second device, a sharing request to the first device;
Receiving, by the second device, the sharing information returned by the first device according to the sharing request, the sharing information includes a folder path and a sharing protocol of the shared folder, wherein the shared folder is a folder in the first device;
Accessing, by the second device, the shared folder according to the sharing protocol and the folder path.

During implementation, the file management function is first enabled in the second device, and then a file sharing request is sent to the first device. When the first device detects the file sharing request, the file sharing service is started, and the sharing information is returned to the second device, and the sharing information may carry relevant information such as an address of the shared space, a user name, and a password.

Based on the sharing information, the second device can access the folder path through the sharing protocol, so as to realize the access to the shared files in the shared folder, so as to access and operate the files in the second operating system based on the file sharing function.

The sharing request and sharing information can be transmitted based on the first communication mode or the second communication mode, and the files to be shared are transmitted through the second communication mode to increase the file transmission speed.

In this embodiment, the sharing protocol can be an existing or improved file sharing protocol. Exemplarily, it can be based on File Transfer Protocol (ftp), sampa (a file sharing service), Network File System (nfs) and other modes for file sharing.

Exemplarily, a shared storage space may be provided through the above-mentioned ftp, samba or nfs protocol, and then the first device sends the sharing information of the shared space to the second device, so that the second device can access the shared space.

In some other embodiments, the file sharing function may be provided based on the second device.

In some embodiments, the method also includes:
Generating, by the second device, a shared space;
Sending, by the second device, space information of the shared space to the first device, wherein the space information includes a folder path and a sharing protocol of the shared space;
Sending, by the first device, the shared file to the second device based on the sharing protocol and the folder path.

In this embodiment, a shared space is generated on the second device, for example, a shared folder may be established to share files in the shared folder.

Next, the space information of the shared space is generated. The space information needs to include at least the folder path of the space information. The first device communicatively connected with the second device can access the shared folder based on the folder path, so as to realize the file transmission to the shared folder or obtain file from the shared folder.

The space information may also include some other information, for example, may include the size, valid time of the shared folder, and the like.

After the space information is generated, then the space information of the shared folder is sent to the first device, and the first device can send the file to be shared to the shared folder based on the space information, or can obtain required files from the shared folder. In this way, the file is equivalent to a local file of the second device. At this time, the second device can directly call the file by calling the local device.

In this way, this embodiment realizes file sharing between the first device and the second device, and improves the interactive control effect between the first device and the second device.

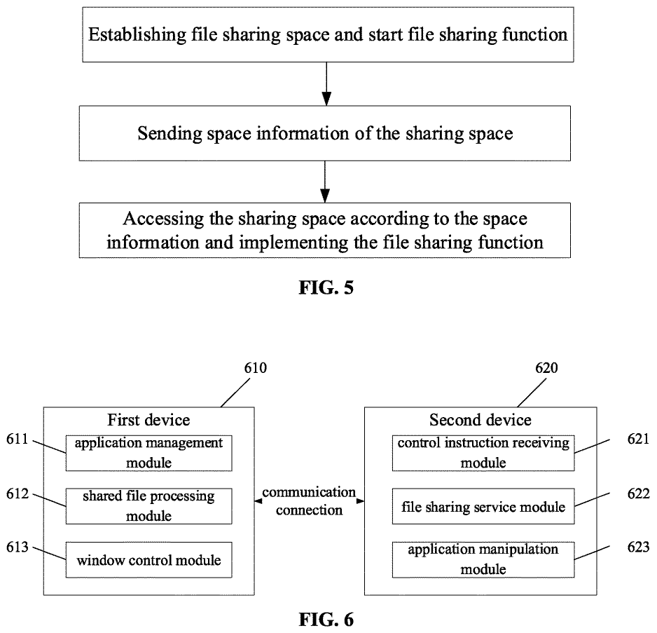

As shown in FIG. 5, the technical solution of this embodiment can be summarized as follows. Firstly, the first device or the second device generates a shared space and enables the file sharing function, and then sends the space information of the shared space to another device, so that the other device can access the shared files in the shared space according to the space information to realize the file sharing function.

In addition, in some embodiments, the file sharing function can also be realized through the cloud server. Specifically, a file sharing space can be provided through the cloud server. During the working process, both the first device and the second device can upload files to the file sharing space and download files from the file sharing space. The file sharing between the first device and the second device is realized.

In some embodiments, file sharing can also be realized by hardware sharing. Specifically, the hardware structure is a data interface or memory. In this embodiment, the hardware structure is used as the data interface, and the data interface is specifically a USB interface.

In one embodiment, a USB interface is provided on the second device, and the USB interface has a switching configuration, which can be switched from hardware to be mounted on the board system of the first device or mounted on the board system of the second device. In this embodiment, a control switch can be set, and the circuit connection state of the USB interface can be controlled through the control switch, so that the USB interface can be mounted on the board system of the first device or mounted on the board system of the second device. During implementation, the files that need to be shared can be stored on mobile storage with USB interface such as U disk, mobile hard disk, and then the mobile storage is connected with the USB interface. When the file needs to be called in the first device, the switch control switch makes the USB interface to be mounted on the board system of the first device, so that the files in the mobile storage can be read based on the first operating system. Similarly, when the file needs to be called in the second device, the switch control switch makes the USB interface to be mounted on the board system of the second device.

When the hardware interface is a memory, its working principle is similar to the above process, and the mounting status of the memory can be controlled by setting the control switch, so as to realize the file sharing function.

As shown in FIG. 6, it can be understood that, compared with related art, in the technical solution of this embodiment, a control instruction receiving module 611, a file sharing service module 612, and an application manipulation module 613 are added to the first device 610. Each module in the first device 610 is a software module.

After the control command receiving module 611 obtains control messages by commanding control channels to monitor messages, the monitored messages may include control messages such as obtaining application list, enabling application, and turning on/off file sharing service.

The file sharing service module 612 executes operations such as turning on/off the file sharing service and configuration of the file sharing service according to the file sharing-related instructions received by the control instruction receiving module 611, and returns the result to the first system through the control instruction receiving module 611.

After the control instruction receiving module 611 receives the instruction on turning on/off application, the application manipulation module 613 can control the application in the first device 610 to be turn on/off in the first operating system, and control the focus of the application.

In the technical solution of this embodiment, a window and input control module 621, an application list management module 622, and a shared file processing module 623 are added to the second device 620, and each module in the second device 620 is a software module.

It should be understood that the second device 620 is the first processor of peripheral input. After the second device 620 receives an external operation input, it can determine whether to send the input event to the first device 610 through a serial port or a USB interface or a transferred hardware module, and can determine whether an event requires conversion.

Exemplarily, when the first operating system installed on the first device 610 is windows, for the second device 620, the long pressing event can be converted into a right-click event and sent to the first device 610. Obviously, the event can also be sent to the first device 610, which is then converted by the first device 610.

The window and input control module 621 has multiple implementation methods depending on the different hardware platforms, including the chip solution supporting the display window zoom of the OPS source input content, the OPS input video signal realizing the video stream of the camera through mipi conversion, etc., that is, when the second device 620 supports that the video output of the first device 610 exists on the display interface of the second device 620 in the form of a sub-window, the window combination display of the two systems can be realized. The second device 620 determines whether the event is distributed to the first device 610 through the position of the touch operation, and whether it is necessary to convert the event before sending it to the first device 610.

The application list management module 622 is used to manage the list of application programs. In the frequently used application list or all application list displayed by the second device 620, management functions such as adding and deleting applications can be supported, and when adding an application, it can be informed to the first device 610 through instruction control communication, to request the application list information of the first device 610. The application list information returned by the first device 610 through the instruction control channel includes the application name and the location link of the application icon. This location link is generated by the file sharing service of the first device 610 or the second device 620, the second device 620 can display and add the application list after obtaining the application list of the first device 610; operation for turning on the application may be set in the application list edited by the second device 620, such as clicking to switch the system and turn on the application, or to turn the application in the window combination method. If the window combination method is used, the display content of the second system will be displayed in the sub-window of the first system, and this window can be moved and zoomed and closed.

The shared file processing module 623 is used to manage the file sharing function. The shared file processing module 623 informs the first device 610 to initialize the file sharing service through the instruction control channel, and if the first device 610 has completed service preparation, the sharing protocol, the root path and the sharing state are informed to the second device 620, and the second device 620 can follow the sharing protocols such as samba, nfs, etc., and generate a file list under the root path, the second device 620 can operate the files of the first device 610, the network sharing of files between the first device 610 and the second device 620 are realized over the the wifi network established therebetween, or by using a physical interface such as usb for large data transmission.

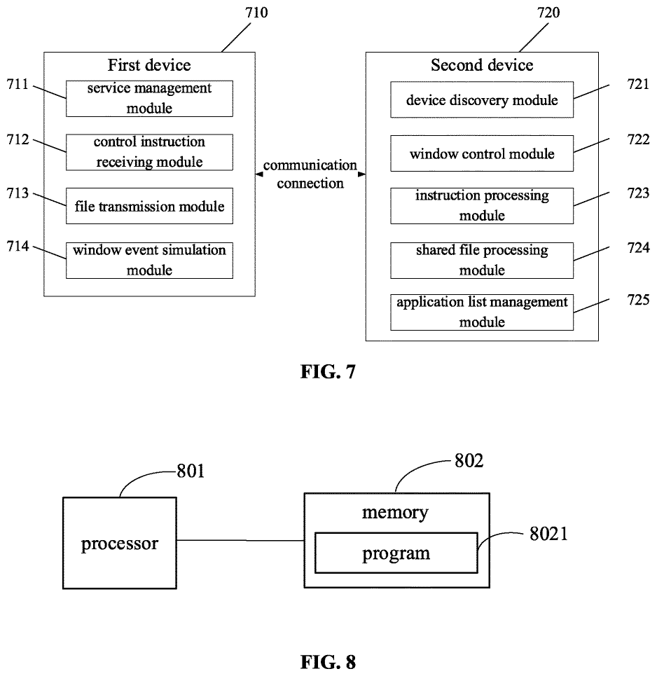

As shown in FIG. 7, in one embodiment, a service management module 711, a control instruction receiving module 712, a file transmission module 713 and a window event simulation module 714 are added to the first device 710, and each module of the first device 710 is a software module.

The service management module 711 interacts with the second device 720 in the background by running a service on the first device 710. The process control of the overall interaction is controlled and scheduled in the service management module, such as the processing of device discovery messages, the obtaining of device screen content, encoding and streaming, etc.

Here, the service mode refers to the difference from the software with a visual window. When running in a service-based mode, the running interface is invisible.

The control instruction receiving module 712 is used to process and execute the command message sent by the second device 720.

The file transmission module 713 places the shared file to a specific path through the file sharing mode specified by the second device 720.

After receiving the touch event message sent by the second device 720, the window event simulation module 714 simulates and sends the event through the system Application Programming Interface (API) to achieve the effect of local interactive control.

A device discovery module 721, a window control module 722, an instruction processing module 723, a shared file processing module 724 and an application list management module 725 are added to the second device 720, and each module in the first device 710 is a software module.

The device discovery module 721 can search and obtain the first device 710 that can perform combination interaction with the second device 720. For example, in the local area network, the UDP communication method can be used to broadcast specific messages. After receiving a specific response message, the device may be added to the list. For device discovery in the wide area network, the cloud device management server may be used as a medium to directly obtain the first device 710 registered on the device management server. After the second device 720 discovers the first device 710, the first device can be displayed in a list, and the first device 710 is selected from the list and added to the current second device 720.

The window control module 722 may establish corresponding display windows according to video signals provided by different first devices 710. It can be understood that, in this embodiment, one second device 720 may correspond to multiple first devices 710, for example, the first device 710 includes an OPS module, and the first device 710 also includes one or more network devices connected based on the local area network or wide area network.

During implementation, each first device 710 may provide a corresponding application program, and the window control module 722 determines the number of currently opened applications to automatically manage the window layout. For example, each running window of an application program may have functions such as closing, moving and zooming, etc., for users to manually adjust.

The screen of the second device 720 can have multiple running windows of applications at the same time, and the applications running on the windows include the application programs installed on the second device 720, the application programs installed on the OPS module, and the application programs installed on the network device, and these three applications can be displayed simultaneously, and the multi-window mechanism of the second device 720 itself, as well as information source management and the media playback capability of the first system itself are used to manage the window content.

In addition to display layout management, the window control module also records the current position and size of each window on the screen, as well as the screen resolution information on the heterogeneous system corresponding to this window, and after the interactive information such as touch on the screen is captured by the first system, the location of the event is converted into the coordinates of the corresponding heterogeneous system for forwarding.

The interactive information is sent to the first device 710 through a serial port or a USB interface or a relayed hardware module, and it can be determined whether the interactive information needs to be format converted as required. Exemplarily, the operating system installed on the second device 720 is Android. When the operating system installed on the first device 710 is windows, the second device 720 may convert the long-press event into a right-click event and send it to the first device 710.

The instruction processing module 723 is used for message interaction with the first device 710, such as obtaining application information installed on the first device 710, opening or closing an application program installed on the first device 710, and sending a touch event to the first device 710, configuring the wifi network connection of the first device 710, reading the file list of the first device 710, configuring the first device 710 to upload local files to a specific address, obtaining the screen display content of a certain area on the first device 710, etc., and receiving feedback and processing of the command execution result of the first device 710.

The shared file processing module 724 is used to implement the file sharing function. In this embodiment, the shared file processing module 724 provides two ways to establish a file sharing mechanism. One is that the first device 710 actively shares files, such as storing the files on nfs, samba, ftp or other cloud servers, and then the first device 710 sends the file address to the second device 720, and the second device 720 downloads and obtains it. The other is that the second device 720 provides a shared storage space through nfs, samba, ftp, etc., and the second device 720 notifies the first device 710 of the access address, user name and password of the storage space, and the first device 710 need to store the shared files to this address.

In one of the embodiments, when a file on the first device 710 needs to be opened on the second device 720, file sharing is first established based on the above process, and the second device 720 opens the directory of the first device 710 through the corresponding file management interface to actually trigger the sending of the obtaining command and wait for the feedback from the first device 710. After receiving the service preparation command, the first device 710 determines whether it has entered the same wifi network as the second device 720. If the first device has not obtained configuration information of the wifi network through the command control channel, and configure the network, initialize the service and configured the file information to be shared, and notify the second device 720 when ready, the second device 720 searches for files by itself through the shared root directory and displays the files, and can process the displayed files.

The application list management module 725 obtains the application information on the heterogeneous system from the first device 710 through command messages, and the information may include application names, version numbers, icon data, file types that can be opened, actual installation paths, etc., and the application list management also includes the display function of the application entrance. The application list of the integrated desktop includes local applications and other application lists on multiple first devices 710; the application in the list can be selected according to the device corresponding to the application and the opening mode, the command message to open the application is sent to the first device 710.

In some aspects of the present disclosure, a display control method is provided, applied to a first device in a display system, the display system includes a first device and a second device, the first device is installed with a first operating system, the second device is installed with a second operating system, the second device includes a display, and the second device can control the display to display a display interface of the second operating system;

The method comprises the steps of:
establishing a communication connection with the second device,
sending the application information of the first application program to the second device, so that the second device displays a first identifier on the display interface of the second operating system according to the application information, wherein the first identifier is an identifier corresponding to the first application program, and the first application program is an application program installed on the first operating system.

In this embodiment, the first device and the second device first need to establish a communication connection. Next, the first device sends application information of the application program installed on the first operating system to the second device.

In some embodiments, the application information is sent according to a display request of the second device.

In some embodiments, after the first device and the second device establish a communication connection, the method further includes:
receiving a display request of the first application sent by the second device;

The sending the application information of the first application program to the second device includes:
sending the application information of the first application program to the second device according to the display request.

In this embodiment, the second device first sends a display request to the first device to obtain information about the first application in the first device. After receiving the display request sent by the second device, the first device sends the application information of the callable first application program to the second device. After receiving the application information, the second device displays the first identifier on the display interface of the second operating system installed on itself.

In this embodiment, the first identifier may be the first application identifier corresponding to the first application program, or the first identifier may be the first folder identifier corresponding to the folder where the first application program is located.

In this embodiment, the first application identifier can be displayed in different ways. For example, the icon of the first application program can be directly displayed as the first application identifier, or the name of the first application program can be displayed as the first application identifier.

In this embodiment, the application information may specifically include information related to the first application program such as the name, icon, startup parameters, application type, and link address of the first application program, so that the second device can display the first identifier according to the application information sent by the first device.

This embodiment can realize that when the second operating system is running, the first identifier on the first device can be displayed on the display interface of the second operating system, and it is not necessary to switch to the first operating system to know the related information of the first application program, which improves the user's operation convenience in the process of using the first device and the second device.

In this embodiment, the identifier corresponding to the first application program can be used in different ways to improve the convenience of use.

In some embodiments, the method also includes:
receiving a start request sent by the second device;
starting the target application program corresponding to the target application identifier according to the start request.

In this embodiment, when the corresponding first application program needs to be run according to the selection of the first identifier, the target application is run by the first device based on the first operating system.

It can be understood that the second device can directly start the first device to run the target application program installed in the first operating system based on the start request. During use, the target application program installed in the first operating system can be started without the operator manually switching the operating system, which improves the convenience of use.

In some embodiments, the method also includes:
Switching the display of the second device to display the display interface of the first operating system;
Running the target application program based on the first operating system, and displaying the running interface of the target application program on the display interface of the first operating system.

In this embodiment, when starting the first application program, the display interface displayed on the display of the second device can be switched to the display interface for displaying the first operating system, and the target application program can be run on the display interface of the first operating system. The running interface of the target application program may be displayed on the display interface of the second operating system.

Specifically, in this embodiment, the video signal provided by the second operating system to the display can be disconnected, and then the display is controlled to access the video signal of the first operating system. In this way, the display interface of the first operating system for running the target application program can be displayed on the display.

In addition, an application window may also be established on the display interface of the second operating system, and the display interface of the target application program is displayed in the application window.

In some embodiments, after the first device starts the target application program according to the start request, the method further includes:
Running, by the first device, the target application program, and sending the application running interface of the target application program to the second device, so as to display the application running interface in the application window of the second device.

In this embodiment, the video signal provided by the second operating system to the display can be disconnected, and then the display is controlled to connect to the video signal of the first operating system. In this way, the display interface running the target application program in the first operating system can be displayed on the display.

As shown in FIG. 4, in this embodiment, it can be understood that a certain area is divided on the display interface of the second operating system as an application window, and the display interface of the first operating system is displayed on the application window.

The implementation of the application window can be based on the widget provided by the Android system, or based on the windowManager function provided by the Android system, a floating window can be established on the display interface of the second operating system as the application window.

Exemplarily, it may be to display the target application interface running based on the first operating system. In this way, it is equivalent to displaying the running content of two operating systems on the same display interface. At this time, the display interface of the first operating system and the display interface of the second operating system may coexist, and the first operating system and the second operating system may run simultaneously.

The application window can be understood as a player running in the floating window or widget mode on the display interface of the second operating system, and the video signal input by the OPS module is converted through Mobile Industry Processor Interface (MIPI) to implement the video stream of camera, the video stream is then played in the player, so that the running interface of the first operating system can be played in the form of video. The size and position of the application window can be fixed, or adjustment widgets can be set, and the size, position, etc. of the application window is adjusted through the adjustment widgets, which will not be further limited here.

During implementation, it can be set to start the target application program by default using the application window or automatically switching the operating system. It is also possible to set different control methods to correspond to different startup methods. For example, it can be set to double-click a certain first application identifier to display the display interface of the corresponding first application program in the application window. It can be set to long press a certain first application identifier, to start the corresponding first application in the manner of switching the operating system. In this embodiment, the specific control manner is not further limited.

In some embodiments, the method also includes:
Receiving a second operation input sent by the second device.

In some embodiments, the method also includes:
receiving a first operation input sent by the second device;
converting the first operation input into a second operation input corresponding to the first device.

Operating instructions may differ in different operating systems. Exemplarily, in the Android system, if the operation options of an application program needs to be opened, it is usually realized by long pressing the icon of the application program, while in the Windows system, it is realized by right-clicking the mouse; if an application program needs to be opened, in the Android system, it is usually realized by single click, while in Windows, it is realized by signal click with the left button of the mouse.

It can be seen that, in different operating systems, specific operation inputs corresponding to the same operation are different.

In this embodiment, if it is detected that the first operation input is input for the area of the application window, that is, for the target application program running in the first operating system, then the first operation input is converted into the second operation input matched with the first operating system, and is sent to the first operating system.

The conversion process can be performed in the first device or in the second device. In other words, in this embodiment, after receiving the first operation input, the second device may convert the first operation input into a second operation input that matches the first device and then send it to the first device, or the first operation input is directly sent to the first device, and then converted into a matching second operation input by the first device.

In this way, in this embodiment, it is possible to operate in the second operating system according to the operating habits corresponding to the second operating system, that is, to control the first device to perform corresponding operating tasks, which simplifies the operation process and improves user experience.

In some embodiments, the first device has a first communication module, the second device has a second communication module, and the first device and the second device establish a connection in the first communication mode via the first communication module and the second communication module; the first device and the second device establish a communication connection in the second communication mode based on the target communication network; the data transmission speed of the second communication mode is greater than that of the first communication mode.

In some embodiments, before the first device sends the application information of the first application program to the second device, the method further includes:
When the first device and the second device are connected through the first communication mode, receiving network access information sent by the second device through the first communication mode;
Accessing the target communication network according to the network access information, wherein when the first device accesses the target communication network, the first device and the second device establish a connection in the second communication mode based on the target communication network.

In this embodiment, the first device and the second device perform data transmission through multiplex communication, so as to improve the convenience and speed of data transmission.

In this embodiment, the first device has a first communication module, the second device has a second communication module, and the first device and the second device establish a connection in the first communication mode through the first communication module and the second communication module. Specifically, the first device and the second device are first connected through the first communication mode. The first communication mode can be selected to implement a relatively simple connection. In some embodiments, the first communication module and the second communication module are serial ports that match to each other, and the first communication mode can be a serial port connection, the serial port refers to an expansion interface with a serial communication mode. The communication line of the serial port can establish a connection by using only a pair of transmission lines, which is relatively simple. The serial port connection can be realized based on the above-mentioned UART interface. In this way, the communication connection between the first device and the second device can be realized directly through the physical data line.

In some embodiments, the method also includes:
Detecting whether the first application program located in the target folder in the first device changes;
Accessing the target communication network according to the network access information when the first application program located in the target folder changes.

In this embodiment, the first device may determine whether to establish a communication connection in the second communication mode with the second device as required. In some embodiments, only when the application program installed in the first device changes or it is necessary to update the relevant information of the first application program that can be used by the second device, the first device establishes the communication connection with the second device in the second communication mode.

Specifically, the first device detects whether the first application program in the target folder changes, specifically, by detecting whether the application list storing the first application program changes, or by detecting whether the application program in the target folder changes, and when the first application program in the target folder changes, the first device accesses the target communication network according to the network access information sent by the second device, so as to establish a communication connection with the second device in the second communication mode.

In some embodiments, the first communication module and the second communication module can also choose other hardware data interfaces, which can conveniently and quickly establish a connection in the first communication mode by means of plugging and unplugging.

After the first device and the second device are connected through the first communication mode, the second device sends network access information to the first device.

It can be understood that some functions of the first device and the second device need to be realized based on the network access function, the second device itself has a display, and due to the nature of the second device itself, the second device can relatively conveniently access to the network through the wireless access point, the network can be a local area network or a wide area network, such as the Internet.

In some embodiments, the second device includes a third communication module, the second device is communicatively connected to the target communication network through the third communication module, and the network access information includes network access information of the target communication network.

The third communication module may be a wifi module. Specifically, in this embodiment, the second device is provided with a wifi module, and accesses the target communication network through the wifi module. Here, the target communication network may be provided by a wireless access point such as a router or a gateway.

In some embodiments, the network access information may specifically include network access information such as the name of the wireless access point, an encryption method, a key, and a password. Based on the network access information, the first device can automatically access the wireless access point based on the network access information, so as to control the first device to access the target communication network and realize network connection. In this way, the first device and the second device can access the target communication network provided by the same wireless access point.

In some embodiments, the second device includes a third communication module, and the target communication network is provided by the second device through the third communication module.

In this embodiment, a wifi module is set on the second device, however, the wifi module is not used to enable the second device to realize network connection, but is used for network sharing. It can be understood that the second device realizes the network connection through other means, and further, establishes a wireless access point based on the wifi module, and the first device accesses the wireless access point established by the wifi module, thereby realizing the network connection.

Specifically, in some embodiments, the second device further includes a fourth communication module, the fourth communication module includes a wireless communication module and/or a network interface. That is to say, the fourth communication module may be a wireless communication module, such as a wifi module, or a wired communication module, such as a network interface that needs to be connected to a communication line.

For example, the network interface may be a network cable interface, the second device can be connected with a network cable to realize network connection. Further, the second device establishes a wireless hotspot through the wifi module to provide network sharing, and the first device accesses the wireless hotspot to realize network connection.

In another embodiment, it can be understood that the second device is provided with two wifi modules, wherein one wifi module is used to realize network connection, the other wifi module is used to establish a wireless hotspot, and the first device establishes a communication connection with the second device through a wireless hotspot established by the wifi module, so that the first device can establish a network connection with the second device through the wifi module for establishing the wireless hotspot, to realize high-speed network data communication between the first device and the second device, and also enable the first device indirectly to implement network access through the second device.

It can be understood that, in this embodiment, for the hardware structure and required software support of the wifi module, reference may be made to related art, and the wifi module itself is not further limited here.

As shown in FIG. 1, in this embodiment, the two-way communication between the first device and the second device can also be realized in other ways. Exemplarily, in some embodiments, the first communication mode is serial port communication. The second communication mode is wireless local area network (WLAN) data communication, specifically, it may be a wifi network; in some other embodiments, the first communication mode is serial port communication, and the second communication mode is Bluetooth communication.

Exemplarily, the second device can transmit Bluetooth pairing information to the first device through the first communication mode, the first device and the second device are equipped with Bluetooth modules, and the first device and the second device can use the Bluetooth module to establish a Bluetooth connection based on the Bluetooth pairing information.

In some of the embodiments, the data transmission speed of the second communication mode is greater than the data transmission speed of the first communication mode. The first communication mode is used to transmit one or more items of network access information, file path information and instruction execution results of the target communication network. Wherein, the file path information may include path information of files shared between the first device and the second device.

The second communication mode is used to transmit one or more items of file data and multimedia data.

In this embodiment, the communication connection established based on the first communication mode is more convenient. For example, when it is based on a serial port connection, it can be directly realized by plugging in the hardware structure. Exemplarily, the OPS module and the intelligent interactive UART interface, etc. The process is simpler. Further, based on the first communication mode, the first device and the second device can establish a second communication mode with faster data transmission speed. In this way, based on the second communication mode, various large files such as files and multimedia data (such as pictures and videos) can be transmitted faster.

In the technical solution of this embodiment, the data transmission speed and convenience are improved through the communication mode of two-way communication.

In some embodiments, the first device and the second device are connected through a local area network, and before the first device sends the application information of the first application program to the second device, the method further includes:
sending response information to the second device, wherein the response information is generated according to broadcast information sent by the second device, and the response information carries device information of the first device.

It can be understood that in this embodiment, the local area network refers to a regional network established in a local area, the distribution area of the local area network is limited, the data transmission speed inside the local area network is faster, the performance is more stable, the framework is simple, and it has a certain degree of closure. The second device may broadcast a specific message within the local area network where it is located. Exemplarily, the above broadcast information may be broadcast in a User Datagram Protocol (UDP) communication mode. The first device and the second device may access the same local area network in different ways such as the wired or wireless ways.

In this embodiment, the first device and the second device can be two devices in the local area network. During implementation, the second device sends broadcast information, and multiple devices that receive the broadcast information can return response information, and the second device can add each device that returns the response information to the device list. Further, the first device among them is confirmed according to the user's selection, and a communication connection with the first device is established according to the device information carried in the response information returned by the first device to realize interaction between the first device and the second device and service sharing of applications, files, etc.

In some other embodiments, the first device and the second device may also establish a communication connection based on a wide area network, for example, the Internet.

In some embodiments, the first device sends the application information of the first application program to the second device, including:
Obtaining application information of the first application program located in the target folder;
sending the application information to the second device;
Wherein, the target folder is a folder with a preset path in the first device.

In some embodiments, the target folder is a desktop folder of the first device and/or a launch bar folder of the first device.

In some embodiments, the method also includes:
Retrieving one or more of an application program of a preset program type, a file of a preset file type, and an application program with a preset name in the target folder as the first application program.

In this embodiment, after the target folder is determined, the first application program in the target folder is further determined. In this embodiment, one or more of an application program of a preset program type, a file of a preset file type, and an application program with a preset name are retrieved in the target folder as the first application program.

Exemplarily, in the case that the first device is an OPS module installed with the windows system, an application program with a preset name and an extension of “.exe” in the target folder may be retrieved as the first application program, or the application program with the preset program type of “executable application” or “application program” can be retrieved as the first application program, or a file with file type of “shortcut” or “shortcut launch method” can also be retrieved as the first application program.

In some embodiments, the method also includes:
receiving a sharing request sent by the second device;
Sending sharing information to the second device according to the sharing request, wherein the sharing information includes a folder path and a sharing protocol of the shared folder, the shared folder is a folder in the first device.

During implementation, the file management function is first enabled in the second device, and then a file sharing request is sent to the first device. When the first device detects the file sharing request, the file sharing service is started, and the sharing information is returned to the second device, and the sharing information may carry relevant information such as an address of the shared space, a user name, and a password.

Based on the sharing information, the second device can access the folder path through the sharing protocol, so as to realize the access to the shared files in the shared folder, so as to access and operate the files in the second operating system based on the file sharing function.

The sharing request and sharing information can be transmitted based on the first communication mode or the second communication mode, and the files to be shared are transmitted through the second communication mode to increase the file transmission speed.

In this embodiment, the sharing protocol can be an existing or improved file sharing protocol. Exemplarily, it can be based on File Transfer Protocol (ftp), sampa (a file sharing service), Network File System (nfs) and other modes for file sharing.

Exemplarily, a shared storage space may be provided through the above-mentioned ftp, samba or nfs protocol, and then the first device sends the sharing information of the shared space to the second device, so that the second device can access the shared space.

In some embodiments, the method also includes:
receiving space information sent by the second device, wherein the space information includes a folder path and a sharing protocol of the shared space;
Sending the shared file to the second device based on the sharing protocol and the folder path.

In this embodiment, a shared space is generated on the second device, for example, a shared folder may be established to share files in the shared folder.

Next, the space information of the shared space is generated. The space information needs to include at least the folder path of the space information. The first device communicatively connected with the second device can access the shared folder based on the folder path, so as to realize the file transmission to the shared folder or obtain file from the shared folder.

The space information may also include some other information, for example, may include the size, valid time of the shared folder, and the like.

After the space information is generated, then the space information of the shared folder is sent to the first device, and the first device can send the file to be shared to the shared folder based on the space information, or can obtain required files from the shared folder. In this way, the file is equivalent to a local file of the second device. At this time, the second device can directly call the file by calling the local device.

In this way, this embodiment realizes file sharing between the first device and the second device, and improves the interactive control effect between the first device and the second device.

In some aspects of the present disclosure, a display control method is provided, applied to a second device in a display system, the display system includes a first device and a second device, the first device is installed with a first operating system, The second device is installed with a second operating system, the second device includes a display, and the second device can control the display to display a display interface of the second operating system;

The method comprises the steps of:
establishing a communication connection with the first device;
receiving application information of a first application program sent by the first device, wherein the first application program is an application program installed on the first operating system;
Displaying a first identifier on a display interface of the second operating system according to the application information, wherein the first identifier is an identifier corresponding to the first application program.

In this embodiment, the first device and the second device first need to establish a communication connection. Next, the first device sends application information of the application program installed on the first operating system to the second device.

In some embodiments, the application information is sent according to a display request of the second device.

In some embodiments, after the first device and the second device establish a communication connection, the method further includes:
sending a display request of the first application program to the first device;
Receiving the application information of the first application program sent by the first device includes:
receiving application information of the first application program sent by the first device according to the display request.

In this embodiment, the second device first sends a display request to the first device to obtain information about the first application program in the first device. After receiving the display request sent by the second device, the first device sends the application information of the first application program to the second device. After receiving the application information, the second device displays the first identifier on the display interface of the second operating system installed on the second device.

In this embodiment, the first identifier may be the first application identifier corresponding to the first application program, or the first identifier may be the first folder identifier corresponding to the folder where the first application program is located.

In this embodiment, the first application identifier can be displayed in different ways. For example, the icon of the first application program can be directly displayed as the first application identifier, or the name of the first application program can be displayed as the first application identifier.

In this embodiment, the application information may specifically include information related to the first application such as the name, icon, startup parameters, application type, and link address of the first application, so that the second device can display the first identifier according to the application information sent by the first device.

In the embodiment, when the second operating system is running, the first identifier on the first device can be displayed on the display interface of the second operating system, and it is not necessary to switch to the first operating system to know the related information of the first application program, which improves the user's operation convenience in the process of using the first device and the second device.

In this embodiment, the identifier corresponding to the first application program can be used in different ways to improve the convenience of use.

In some embodiments, the second device displays the first identifier on the display interface of the second operating system according to the application information, including:
Displaying a menu identifier on the first interface of the second operating system;
When an access request for the menu identifier is received, displaying a second interface including the first identifier.

Exemplarily, in this embodiment, a folder can be opened as the second interface, and the first identifier can be displayed in the folder; as another example, an application list can also be expanded as the second interface, and the first identifier can be displayed in the application list. In addition, a submenu of the menu identifier can also be set, and the submenu can be used as the second interface for displaying the first identifier.

In some embodiments, the first interface is a functional interface of the handwriting software of the second operating system, and the first identifier corresponding to the first application program can be displayed in the form of an icon or a list on the functional interface.

In some embodiments, the handwriting software is specifically used as a handwriting board to provide handwriting functions during the meeting. In this way, the handwriting software is equivalent to a “conference whiteboard”. When using it, participants can write content on the handwriting interface of the handwriting software to show to the participants.

The first interface is set as the functional interface of the handwriting software, so that when the first application program needs to be used, the second interface can be conveniently and quickly expanded based on the functional interface. For example, an icon on the functional interface of the handwriting software is used as the menu identifier, user clicks the menu identifier to open the second interface with the first identifier, the second interface and the first interface may have partly the same content, for example, only a sub-window in a part of region of the first interface is opened to display the first identifier, and further select the first identifier to improve the convenience of operation.

In some embodiments, the method also includes:
When receiving an initial access request for the menu identifier, determining whether the second device establishes a communication connection with the first device,
If no communication connection has been established with the first device, establishing a communication connection with the first device based on the initial access request.

In some embodiments, the first interface is a functional interface of handwriting software of the second operating system.

The first device is the OPS module, and the second device is an intelligent interactive tablet. When the menu identifier is clicked on the second device for the first time to generate an initial access request for the menu identifier, it is first detected whether the first device establishes communication connection to the second device. If no communication connection has been established, a communication connection between the first device and the second device needs to be established.

Further, in some embodiments, the first device may be in a standby or power-off state, and when the menu identifier is clicked, the first device can be woken up or controlled to start up, so as to establish communication connection between the first device and the second device.

During implementation, the first device can be woken up or controlled to be turned on, or a prompt window can pop up for the user to select whether to control the wakeup of the first device or control the first device to be turned on in the prompt window.

In some embodiments, the second device displays the first identifier on the display interface of the second operating system according to the application information, including:
Displaying at least one first identifier and at least one second identifier on a display interface of the second operating system, wherein the second identifier is an identifier corresponding to a second application program installed on the second operating system.

In some embodiments, the first identifier and the second identifier can also be displayed in the same interface, for example, the first identifier and the second identifier can be displayed in the same folder. The styles of the first identifier and the second identifier may be the same or different. For example, a specific symbol may be added to the first identifier to indicate that the identifier is the first identifier on the first device.

By displaying the first identifier and the second identifier on the same interface, it is convenient for the user to fully understand the application programs that can be used, and the convenience of use is improved.

In some embodiments, the method also includes:
receiving an access request for the target application identifier in the first identifier;
Sending a start request to the first device, so that the first device starts the target application program corresponding to the target application identifier according to the start request.

In this embodiment, when the corresponding first application program needs to be run according to the selection of the first identifier, the target application is run by the first device based on the first operating system.

It can be understood that based on the start request, the second device can directly start the first device to run the target application program installed in the first operating system. During use, it is not necessary for the operator to manually switch the operating system, the target application program in the first operating system can be started and the convenience of use is improved.

In some embodiments, the method also includes:
Switching the display of the second device to display the display interface of the first operating system, so that the first device runs the target application program based on the first operating system, and a running interface of the target application program is displayed on the display interface of the first operating system.

In this embodiment, when starting the first application program, the display interface displayed on the display of the second device can be switched to display the display interface of the first operating system, and the target application program can be run on the display interface of the first operating system. The running interface of the target application program may be displayed on the display interface of the second operating system.

Specifically, in this embodiment, the video signal provided by the second operating system to the display can be disconnected, and then the display is controlled to access the video signal of the first operating system. In this way, the display interface of the target application program can be run in the first operating system and can be displayed on the display.

In addition, an application window may also be established on the display interface of the second operating system, and the display interface of the target application program is displayed in the application window.

In some embodiments, the method also includes:
Generating an application window on the display interface of the second operating system, and the application window corresponding to at least part area of the display interface;
receiving an application running interface for the first device to run the target application program;
displaying the application running interface in the application window.

As shown in FIG. 4, in this embodiment, it can be understood that a certain area is divided on the display interface of the second operating system as an application window, and the display interface of the first operating system is displayed on the application window.

The implementation of the application window can be based on the widget provided by the Android system, or based on the window Manager function provided by the Android system, a floating window can be established on the display interface of the second operating system as the application window.

Exemplarily, it may be to display the target application interface running based on the first operating system. In this way, it is equivalent to displaying the running content of two operating systems on the same display interface. At this time, the display interface of the first operating system and the display interface of the second operating system may coexist, and the first operating system and the second operating system may run simultaneously.

The application window can be understood as a player running in the floating window or widget mode on the display interface of the second operating system, and the video signal input by the OPS module is converted through Mobile Industry Processor Interface (MIPI) to realize the video stream of the camera, the video stream is then played in the player, so that the running interface of the first operating system can be played in the form of video. The size and position of the application window can be fixed, or adjustment controls can be set to adjust the size, position, etc. of the application window, which will not be further limited here.

During implementation, it can be set to start the target application program by default using the application window or automatically switching the operating system. It is also possible to set different control methods to correspond to different startup methods. For example, it can be set to double-click a certain first application identifier to display the display interface of the corresponding first application program in the application window, or press a certain first application identifier for a long time, to start the corresponding first application in the mode of switching the operating system. In this embodiment, the specific control method is not further limited.

In some embodiments, the method also includes:
receiving a first operation input for an area corresponding to the application window;
converting the first operation input into a second operation input corresponding to the first device;
sending the second operation input to the first device.

In some embodiments, after the second device generates the application window on the display interface of the second operating system, the method further includes:
receiving a first operation input for an area corresponding to the application window;
sending the first operation input to the first device.

Operating instructions may differ in different operating systems. Exemplarily, in the Android system, if the operation options of an application is to be opened, it is usually realized by pressing the icon of the application for a long time, while in the Windows system, it is realized by right-clicking the mouse; if an application program is to be opened, in the Android system, it is usually realized by single-click, while in Windows, it is realized by single-click with the left button of the mouse.

It can be seen that, in different operating systems, specific operation inputs corresponding to the same operation are different.

In this embodiment, if it is detected that the first operation input is for the area of the application window, that is, for the target application program running in the first operating system, then the first operation input is converted into the second operation input matched with the first operating system, the second operation input is sent to the first operating system.

The conversion process can be performed in the first device or in the second device. In other words, in this embodiment, after receiving the first operation input, the second device may convert the first operation input into a second operation input that matches the first device and then send it to the first device, or the first operation input is directly sent to the first device, and then the first device converts the first operation input into a second operation input matching with the first operation input.

In this way, in this embodiment, it is possible to operate in the second operating system according to the operating habits corresponding to the second operating system, that is, to control the first device to perform corresponding operating tasks, which simplifies the operation process and improves user experience.

In this embodiment, the first device and the second device may be controlled in different ways to establish a communication connection.

In some embodiments, the first device has a first communication module, the second device has a second communication module, and the first device and the second device establish a connection in the first communication mode through the first communication module and the second communication module; the first device and the second device establish a connection in the second communication mode based on the target communication network; the data transmission speed in the second communication mode is greater than the data transmission speed in the first communication mode.

In some embodiments, the first device and the second device may be controlled to establish a communication connection in the following modes:
When the first device and the second device are connected through a first communication mode, the second device sends network access information to the first device through the first communication mode;
The first device accesses the target communication network according to the network access information, wherein when the first device accesses the target communication network, the first device and the second device establish a connection in the second communication mode based on the target communication network.

In this embodiment, the first device and the second device perform data transmission through multiplex communication, so as to improve the convenience and speed of data transmission.

In this embodiment, the first device has a first communication module, the second device has a second communication module, and the first device and the second device establish a connection in the first communication mode through the first communication module and the second communication module. Specifically, the first device and the second device are first connected through the first communication mode. The first communication mode can be selected to implement a relatively simple connection mode. In some embodiments, the first communication module and the second communication module are serial ports that match to each other, and the first communication mode can be a serial port connection. The serial port refers to an expansion interface using a serial communication mode. The communication line of the serial port can establish a connection by using only a pair of transmission lines, which is relatively simple. The serial port connection can be realized based on the above-mentioned UART interface. In this way, the communication connection between the first device and the second device can be realized directly through the physical data line.

In some embodiments, before the first device accesses the target communication network according to the network access information, the method further includes:
Detecting, by the first device, whether the first application program located in the target folder in the first device changes;
Accessing, by the first device, the target communication network according to the network access information when the first application program located in the target folder changes.

In this embodiment, the first device may determine whether to establish a communication connection in the second communication mode with the second device as required. In some embodiments, only when the application program installed in the first device changes or it is necessary to update the relevant information of the first application program that can be used by the second device, the first device establishes the communication connection with the second device in the second communication mode.

Specifically, the first device detects whether the first application program in the target folder changes, specifically, by detecting whether the application list storing the first application program changes, or by detecting whether the application program in the target folder changes, and when the first application program in the target folder changes, the first device accesses the target communication network according to the network access information sent by the second device, so as to establish a communication connection with the second device in the second communication mode.

In some embodiments, the first communication module and the second communication module can also choose other hardware data interfaces, which can conveniently and quickly establish a connection in the first communication mode by means of plugging and unplugging.

After the first device and the second device are connected through the first communication mode, the second device sends network access information to the first device.

It can be understood that some functions of the first device and the second device need to be realized based on the network access function, the second device itself has a display, and due to the nature of the second device itself, the second device can relatively conveniently access to the network through the wireless access point, the network can be a local area network or a wide area network, such as the Internet.

In some embodiments, the second device includes a third communication module, the second device is communicatively connected to the target communication network through the third communication module, and the network access information includes network access information of the target communication network.

The third communication module may be a wifi module. Specifically, in this embodiment, the second device is provided with a wifi module, and accesses the target communication network through the wifi module. Here, the target communication network may be provided by a wireless access point such as a router or a gateway.

In some embodiments, the network access information may specifically include network access information such as the name of the wireless access point, an encryption method, a key, and a password. Based on the network access information, the first device can automatically access the wireless access point based on the network access information, so as to control the first device to access the target communication network and realize network connection. In this way, the first device and the second device can access the target communication network provided by the same wireless access point.

In some embodiments, the second device includes a third communication module, and the target communication network is provided by the second device through the third communication module.

In this embodiment, a wifi module is set on the second device, however, the wifi module is not used to enable the second device to realize network connection, but is used for network sharing. It can be understood that the second device realizes the network connection through other means, and further, establishes a wireless access point based on the wifi module, and the first device accesses the wireless access point established by the wifi module, thereby realizing the network connection.

Specifically, in some embodiments, the second device further includes a fourth communication module, the fourth communication module includes a wireless communication module and/or a network interface. That is to say, the fourth communication module may be a wireless communication module, such as a wifi module, or a wired communication module, such as a network interface that needs to be connected to a communication line.

For example, the network interface may be a network cable interface, the second device can be connected with a network cable to realize network connection. Further, the second device establishes a wireless hotspot through the wifi module to provide network sharing, and the first device accesses the wireless hotspot to realize network connection.

In another embodiment, it can be understood that the second device is provided with two wifi modules, wherein one wifi module is used to realize network connection, the other wifi module is used to establish a wireless hotspot, and the first device establishes a communication connection with the second device through a wireless hotspot established by the wifi module, so that the first device can establish a network connection with the second device through the wifi module for establishing the wireless hotspot, to realize high-speed network data communication between the first device and the second device, and also enable the first device indirectly to implement network access through the second device.

It can be understood that, in this embodiment, for the hardware structure and required software support of the wifi module, reference may be made to related art, and the wifi module itself is not further limited here.

As shown in FIG. 1, in this embodiment, the two-way communication between the first device and the second device can also be realized in other ways. Exemplarily, in some embodiments, the first communication mode is serial port communication. The second communication mode is wireless local area network (WLAN) data communication, specifically, it may be a wifi network; in some other embodiments, the first communication mode is serial port communication, and the second communication mode is Bluetooth communication.

Exemplarily, the second device can transmit Bluetooth pairing information to the first device through the first communication mode, the first device and the second device are equipped with Bluetooth modules, and the first device and the second device can use the Bluetooth module to establish a Bluetooth connection based on the Bluetooth pairing information.

In some of the embodiments, the data transmission speed of the second communication mode is greater than the data transmission speed of the first communication mode. The first communication mode is used to transmit one or more items of network access information, file path information and instruction execution results of the target communication network. Wherein, the file path information may include path information of files shared between the first device and the second device.

The second communication mode is used to transmit one or more items of file data and multimedia data.

In this embodiment, the communication connection established based on the first communication mode is more convenient. For example, when it is based on a serial port connection, it can be directly realized by plugging in the hardware structure. Exemplarily, the OPS module and the intelligent interactive UART interface, etc. The process is simpler. Further, based on the first communication mode, the first device and the second device can establish a second communication mode with faster data transmission speed. In this way, based on the second communication mode, various large files such as files and multimedia data (such as pictures and videos) can be transmitted faster.

In the technical solution of this embodiment, the data transmission speed and convenience are improved through the communication mode of two-way communication.

In some embodiments, the first device and the second device are connected through a local area network, and before the first device sends the application information of the first application program to the second device, the method further includes:
Sending broadcast information to the local area network;
receiving response information sent by the first device, wherein the response information is generated according to the broadcast information, and the response information carries device information of the first device;
Establishing a communication connection with the first device according to the response information.

It can be understood that in this embodiment, the local area network refers to a regional network established in a local area, the distribution area of the local area network is limited, the data transmission speed inside the local area network is faster, the performance is more stable, the framework is simple, and it has a certain degree of closure. The second device may broadcast a specific message within the local area network where it is located. Exemplarily, the above broadcast information may be broadcast in a User Datagram Protocol (UDP) communication mode. The first device and the second device may access the same local area network in different ways such as the wired or wireless ways.

In some embodiments, the second device establishes a communication connection with the first device according to the response information, including:
adding the first device to a device list according to the response information;
obtaining a selection instruction for the first device;
Establishing a communication connection with the first device according to the selection instruction.

In this embodiment, the first device and the second device can be two devices in the local area network. During implementation, the second device sends broadcast information, and multiple devices that receive the broadcast information can return response information, and the second device can add each device that returns the response information to the device list. Further, the first device among them is confirmed according to the user's selection, and a communication connection with the first device is established according to the device information carried in the response information returned by the first device to realize interaction between the first device and the second device and service sharing of applications, files, etc.

In some other embodiments, the first device and the second device may also establish a communication connection based on a wide area network, for example, the Internet.

In some embodiments, the display system further includes a management server, and the method further includes:
Sending a connection request to the management server;
receiving the device information of the first device sent by the management server according to the connection request, wherein the first device is pre-registered in the management server;
Establishing a communication connection with the first device according to the device information.

In this embodiment, each device that can provide services is first registered in the management server. When the second device needs to establish a communication connection with the first device, the first device can be selected from the list of registered devices provided by the management server, and further establishes the communication connection with the first device based on the relevant information of the first device carried in the registration information.

It can be understood that when the first device and the second device are connected through a local area network or a wide area network, all interactive data such as command messages, file data, and instruction execution results between the first device and the second device are transmitted through the local area network or the wide area network.

In some embodiments, the method also includes:
sending a sharing request to the first device;
receiving sharing information returned by the first device according to the sharing request, the sharing information including a folder path and a sharing protocol of a shared folder, wherein the shared folder is a folder in the first device;
accessing the shared folder according to the sharing protocol and the folder path.

During implementation, the file management function is first enabled in the second device, and then a file sharing request is sent to the first device. When the first device detects the file sharing request, the file sharing service is started, and the sharing information is returned to the second device, and the sharing information may carry relevant information such as an address of the shared space, a user name, and a password.

Based on the sharing information, the second device can access the folder path through the sharing protocol, so as to realize the access to the shared files in the shared folder, so as to access and operate the files in the second operating system based on the file sharing function.

The sharing request and sharing information can be transmitted based on the first communication mode or the second communication mode, and the files to be shared are transmitted through the second communication mode to increase the file transmission speed.

In this embodiment, the sharing protocol can be an existing or improved file sharing protocol. Exemplarily, it can be based on File Transfer Protocol (ftp), sampa (a file sharing service), Network File System (nfs) and other modes for file sharing.

Exemplarily, a shared storage space may be provided through the above-mentioned ftp, samba or nfs protocol, and then the first device sends the sharing information of the shared space to the second device, so that the second device can access the shared space.

In some embodiments, the method also includes:
generating a shared space;
sending space information of the shared space to the first device, wherein the space information includes a folder path and a sharing protocol of the shared space;
receiving a shared file sent by the first device based on the sharing protocol and the folder path.

In this embodiment, a shared space is generated on the second device, for example, a shared folder may be established to share files in the shared folder.

Next, the space information of the shared space is generated. The space information needs to include at least the folder path of the space information. The first device communicatively connected with the second device can access the shared folder based on the folder path, so as to realize the file transmission to the shared folder or obtain file from the shared folder.

The space information may also include some other information, for example, may include the size, valid time of the shared folder, and the like.

After the space information is generated, then the space information of the shared folder is sent to the first device, and the first device can send the file to be shared to the shared folder based on the space information, or can obtain required files from the shared folder. In this way, the file is equivalent to a local file of the second device. At this time, the second device can directly call the file by calling the local device.

In this way, this embodiment realizes file sharing between the first device and the second device, and improves the interactive control effect between the first device and the second device.

It should be understood that, in this embodiment, the display control method applied to the first device and the display control method applied to the second device can refer to the above-mentioned display control method applied to the display system, implemented by the first device and the second device.

In some aspects of the present disclosure, a display system is provided, the display system includes a first device and a second device, the first device is installed with a first operating system, and the second device is installed with a second operating system, the second device includes a display, and the second device can control the display to display a display interface of the second operating system.

The second device is configured to:
establish a communication connection between the first device and the second device;

The first device is configured to:
send application information of a first application program to the second device, wherein the first application program is an application program installed on the first operating system;
The second device is further configured to:
display a first identifier on a display interface of the second operating system according to the application information.

In this embodiment, the first device and the second device first need to establish a communication connection. Next, the first device sends application information of the application program installed on the first operating system to the second device.

In some embodiments, the second device is configured to:
send a display request of the first application program to the first device;
The first device is configured to:
send the application information of the first application program to the second device according to the display request.

In this embodiment, the second device first sends a display request to the first device to obtain information about the first application program in the first device. After receiving the display request sent by the second device, the first device sends the application information of the first application program to the second device. After receiving the application information, the second device displays the first identifier on the display interface of the second operating system installed on the second device.

In this embodiment, the first identifier may be the first application identifier corresponding to the first application program, and the first identifier may also be a first folder identifier corresponding to a folder where the first application program is located.

In this embodiment, the first application identifier can be displayed in different ways. For example, an icon of the first application program can be directly displayed as the first application identifier, or a name of the first application program can be displayed as the first application identifier.

In this embodiment, the application information may specifically include information related to the first application such as the name, icon, startup parameters, application type, and link address of the first application, so that the second device can display the first identifier according to the application information sent by the first device.

In the embodiment, when the second operating system is running, the first identifier on the first device can be displayed on the display interface of the second operating system, and it is not necessary to switch to the first operating system to know the related information of the first application program, which improves the user's operation convenience in the process of using the first device and the second device.

In this embodiment, the identifier corresponding to the first application program can be used in different ways to improve the convenience of use.

In some embodiments, the first device is an external computer module. In some embodiments, the external computer module may be an OPS module. In this embodiment, only the external computer module is an OPS module for illustration. The second device is an intelligent interactive tablet, the intelligent interactive tablet includes a communication interface, and the OPS module communicates with the intelligent interactive tablet through the communication interface. For the structure of the OPS module and the connection mode between the OPS module and the intelligent interactive tablet, reference may be made to the embodiment shown in FIG. 1, which will not be repeated here.

In some embodiments, when the second device displays the first identifier on the display interface of the second operating system according to the application information, the second device specifically configured to:
display a menu identifier on the first interface of the second operating system;
When an access request for the menu identifier is received, display a second interface including the first identifier.

In this embodiment, a menu identifier can be displayed first, and the user can access the menu identifier in different ways, for example, the menu identifier can be accessed by clicking, voice control, mouse control, touchpad control and other ways.

When the user accesses the menu identifier, a second interface including the first identifier is displayed.

Exemplarily, in this embodiment, a folder can be opened as the second interface, and the first identifier can be displayed in the folder; as another example, an application list can also be expanded as the second interface, and the first identifier can be displayed in the application list. In addition, a submenu of the menu identifier can also be set, and the submenu can be used as the second interface for displaying the first identifier.

In some embodiments, the first interface is a functional interface of the handwriting software of the second operating system, and the first identifier corresponding to the first application program can be displayed in the form of an icon or a list on the functional interface.

In some embodiments, the handwriting software is specifically used as a handwriting board to provide handwriting functions during the meeting. In this way, the handwriting software is equivalent to a “conference whiteboard”. When using it, participants can write content on the handwriting interface of the handwriting software to show to the participants.

The first interface is set as the functional interface of the handwriting software, so that when the first application program needs to be used, the second interface can be conveniently and quickly expanded based on the functional interface. For example, an icon on the functional interface of the handwriting software is used as the menu identifier, user clicks the menu identifier to open the second interface with the first identifier, the second interface and the first interface may have partly the same content, for example, only a sub-window in a part of region of the first interface is opened to display the first identifier, and further select the first identifier to improve the convenience of operation.

In some embodiments, the second device is configured to:
when receiving an initial access request for the menu identifier, determine whether the second device establishes communication connection with the first device,
if the second device has not established communication connection with the first device, establish communication connection with the first device based on the initial access request.

The first device is the OPS module, and the second device is an intelligent interactive tablet. When the menu identifier is clicked on the second device for the first time to generate an initial access request for the menu identifier, it is first detected whether the first device establishes communication connection to the second device. If no communication connection has been established, a communication connection between the first device and the second device needs to be established.

Further, in some embodiments, the first device may be in a standby or power-off state, and when the menu identifier is clicked, the first device can be woken up or controlled to start up, so as to establish communication connection between the first device and the second device.

During implementation, the first device can be woken up or controlled to be turned on, or a prompt window can pop up for the user to select whether to control the wakeup of the first device or control the first device to be turned on in the prompt window.

In some embodiments, when the second device displays the first identifier on the display interface of the second operating system according to the application information, it is specifically configured to:
display at least one first identifier and at least one second identifier on a display interface of the second operating system, wherein the second identifier is an identifier corresponding to a second application program installed on the second operating system.

In some embodiments, the first identifier and the second identifier can also be displayed in the same interface, for example, the first identifier and the second identifier can be displayed in the same folder. The styles of the first identifier and the second identifier may be the same or different. For example, a specific symbol may be added to the first identifier to indicate that the identifier is the first identifier on the first device.

By displaying the first identifier and the second identifier on the same interface, it is convenient for the user to fully understand the application programs that can be used, and the convenience of use is improved.

In some embodiments, the second device is further configured to:
Receive an access request for a target application identifier in the first identifier;
Send a start request to the first device;
The first device is further configured to:
Start a target application program corresponding to the target application identifier according to the start request.

In this embodiment, when the corresponding first application program needs to be run according to the selection of the first identifier, the target application is run by the first device based on the first operating system.

It can be understood that based on the start request, the second device can directly start the first device to run the target application program installed in the first operating system. During use, it is not necessary for the operator to manually switch the operating system, the target application program in the first operating system can be started and the convenience of use is improved.

In some embodiments, after the first device starts the target application program according to the start request, the method further includes:
switch the display of the second device to display the display interface of the first operating system;
the first device is configured to:
run the target application program based on the first operating system, and displaying a running interface of the target application program on a display interface of the first operating system.

In this embodiment, when starting the first application program, the display interface displayed on the display of the second device can be switched to display the display interface of the first operating system, and the target application program can be run on the display interface of the first operating system. The running interface of the target application program may be displayed on the display interface of the second operating system.

Specifically, in this embodiment, the video signal provided by the second operating system to the display can be disconnected, and then the display is controlled to access the video signal of the first operating system. In this way, the display interface of the target application program can be run in the first operating system and can be displayed on the display.

In addition, an application window may also be established on the display interface of the second operating system, and the display interface of the target application program is displayed in the application window.

In some embodiments, the second device is further configured to: generate an application window on the display interface of the second operating system, and the application window corresponding to at least part area of the display interface;
The first device is further configured to: run the target application program, and send an application running interface of the target application program to the second device;
The second device is further configured to: display the application running interface in the application window.

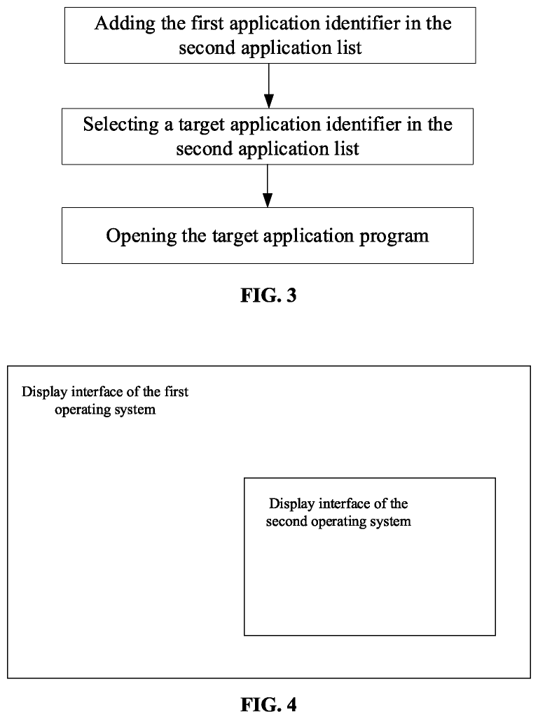

As shown in FIG. 3, in this embodiment, it can be understood that a certain area is divided on the display interface of the second operating system as an application window, and the display interface of the first operating system is displayed on the application window.

The implementation of the application window can be based on the widget provided by the Android system, or based on the window Manager function provided by the Android system, a floating window can be established on the display interface of the second operating system as the application window.

Exemplarily, it may be to display the target application interface running based on the first operating system. In this way, it is equivalent to displaying the running content of two operating systems on the same display interface. At this time, the display interface of the first operating system and the display interface of the second operating system may coexist, and the first operating system and the second operating system may run simultaneously.

The application window can be understood as a player running in the floating window or widget mode on the display interface of the second operating system, and the video signal input by the OPS module is converted through Mobile Industry Processor Interface (MIPI) to realize the video stream of the camera, the video stream is then played in the player, so that the running interface of the first operating system can be played in the form of video. The size and position of the application window can be fixed, or adjustment controls can be set to adjust the size, position, etc. of the application window, which will not be further limited here.

As shown in FIG. 3, the technical solution of this embodiment can be summarized as follows. First, the first identifier of the first application program in the first device is added to the second application list of the second device, and when the application program selected in the application list in the second device is the target application identifier corresponding to the target application program in the first device, the target application program can be opened by displaying a small window in a window combination mode or an operating system switching mode, and finally, combination display and control are implemented for the target application program, to display the running interface of the target application, in this way, the application program in the second operating system can be called from the first operating system without system switching first.

During implementation, it can be set to start the target application program by default using the application window or automatically switching the operating system. It is also possible to set different control methods to correspond to different startup methods. For example, it can be set to double-click a certain first application identifier to display the display interface of the corresponding first application program in the application window, or press a certain first application identifier for a long time, to start the corresponding first application in the mode of switching the operating system. In this embodiment, the specific control method is not further limited.

In some embodiments, the second device is further configured to:
Receive a first operation input for an area corresponding to the application window;
Convert the first operation input into a second operation input corresponding to the first device;
Send the second operation input to the first device.

In some other embodiments, the second device is further configured to:
Receive a first operation input for an area corresponding to the application window;
Send the first operation input to the first device;
Convert the first operation input into a second operation input corresponding to the first device.

Operating instructions may differ in different operating systems. Exemplarily, in the Android system, if the operation options of an application is to be opened, it is usually realized by pressing the icon of the application for a long time, while in the Windows system, it is realized by right-clicking the mouse; if an application program is to be opened, in the Android system, it is usually realized by single-click, while in Windows, it is realized by single-click with the left button of the mouse.

It can be seen that, in different operating systems, specific operation inputs corresponding to the same operation are different.

In this embodiment, if it is detected that the first operation input is for the area of the application window, that is, for the target application program running in the first operating system, then the first operation input is converted into the second operation input matched with the first operating system, the second operation input is sent to the first operating system.

The conversion process can be performed in the first device or in the second device. In other words, in this embodiment, after receiving the first operation input, the second device may convert the first operation input into a second operation input that matches the first device and then send it to the first device, or the first operation input is directly sent to the first device, and then the first device converts the first operation input into a second operation input matching with the first operation input.

In this way, in this embodiment, it is possible to operate in the second operating system according to the operating habits corresponding to the second operating system, that is, to control the first device to perform corresponding operating tasks, which simplifies the operation process and improves user experience.

In this embodiment, the first device and the second device may be controlled in different ways to establish a communication connection.

In some embodiments, the second device is further configured to: in the case that the first device and the second device are connected through the first communication mode, send network access information to the first device through the first communication mode;

The first device is configured to: access a target communication network according to the network access information, wherein when the first device accesses the target communication network, the first device and the second device establish a connection in the second communication mode based on the target communication network.

In this embodiment, the first device and the second device perform data transmission through multiplex communication, so as to improve the convenience and speed of data transmission.

In this embodiment, the first device has a first communication module, the second device has a second communication module, and the first device and the second device establish a connection in the first communication mode through the first communication module and the second communication module. Specifically, the first device and the second device are first connected through the first communication mode. The first communication mode can be selected to implement a relatively simple connection mode. In some embodiments, the first communication module and the second communication module are serial ports that match to each other, and the first communication mode can be a serial port connection. The serial port refers to an expansion interface using a serial communication mode. The communication line of the serial port can establish a connection by using only a pair of transmission lines, which is relatively simple. The serial port connection can be realized based on the above-mentioned UART interface. In this way, the communication connection between the first device and the second device can be realized directly through the physical data line.

In some embodiments, the first device is configured to:
Detect whether the first application program located in the target folder in the first device changes;
Access the target communication network according to the network access information when the first application program located in the target folder changes.

In this embodiment, the first device may determine whether to establish a communication connection in the second communication mode with the second device as required. In some embodiments, only when the application program installed in the first device changes or it is necessary to update the relevant information of the first application program that can be used by the second device, the first device establishes the communication connection with the second device in the second communication mode.

Specifically, the first device detects whether the first application program in the target folder changes, specifically, by detecting whether the application list storing the first application program changes, or by detecting whether the application program in the target folder changes, and when the first application program in the target folder changes, the first device accesses the target communication network according to the network access information sent by the second device, so as to establish a communication connection with the second device in the second communication mode.

In some embodiments, the first communication module and the second communication module can also choose other hardware data interfaces, which can conveniently and quickly establish a connection in the first communication mode by means of plugging and unplugging.

After the first device and the second device are connected through the first communication mode, the second device sends network access information to the first device.

It can be understood that some functions of the first device and the second device need to be realized based on the network access function, the second device itself has a display, and due to the nature of the second device itself, the second device can relatively conveniently access to the network through the wireless access point, the network can be a local area network or a wide area network, such as the Internet.

In some embodiments, the second device includes a third communication module, the second device is communicatively connected to the target communication network through the third communication module, and the network access information includes network access information of the target communication network.

The third communication module may be a wifi module. Specifically, in this embodiment, the second device is provided with a wifi module, and accesses the target communication network through the wifi module. Here, the target communication network may be provided by a wireless access point such as a router or a gateway.

In some embodiments, the network access information may specifically include network access information such as the name of the wireless access point, an encryption method, a key, and a password. Based on the network access information, the first device can automatically access the wireless access point based on the network access information, so as to control the first device to access the target communication network and realize network connection. In this way, the first device and the second device can access the target communication network provided by the same wireless access point.

In some of the embodiments, the second device includes a third communication module, and the target communication network is provided by the second device through the third communication module.

In this embodiment, a wifi module is set on the second device, however, the wifi module is not used to enable the second device to realize network connection, but is used for network sharing. It can be understood that the second device realizes the network connection through other means, and further, establishes a wireless access point based on the wifi module, and the first device accesses the wireless access point established by the wifi module, thereby realizing the network connection.

Specifically, in some embodiments, the second device further includes a fourth communication module, the fourth communication module includes a wireless communication module and/or a network interface. That is to say, the fourth communication module may be a wireless communication module, such as a wifi module, or a wired communication module, such as a network interface that needs to be connected to a communication line.

For example, the network interface may be a network cable interface, the second device can be connected with a network cable to realize network connection. Further, the second device establishes a wireless hotspot through the wifi module to provide network sharing, and the first device accesses the wireless hotspot to realize network connection.

In another embodiment, it can be understood that the second device is provided with two wifi modules, wherein one wifi module is used to realize network connection, the other wifi module is used to establish a wireless hotspot, and the first device establishes a communication connection with the second device through a wireless hotspot established by the wifi module, so that the first device can establish a network connection with the second device through the wifi module for establishing the wireless hotspot, to realize high-speed network data communication between the first device and the second device, and also enable the first device indirectly to implement network access through the second device.

It can be understood that, in this embodiment, for the hardware structure and required software support of the wifi module, reference may be made to related art, and the wifi module itself is not further limited here.

As shown in FIG. 1, in this embodiment, the two-way communication between the first device and the second device can also be realized in other ways. Exemplarily, in some embodiments, the first communication mode is serial port communication. The second communication mode is wireless local area network (WLAN) data communication, specifically, it may be a wifi network; in some other embodiments, the first communication mode is serial port communication, and the second communication mode is Bluetooth communication.

Exemplarily, the second device can transmit Bluetooth pairing information to the first device through the first communication mode, the first device and the second device are equipped with Bluetooth modules, and the first device and the second device can use the Bluetooth module to establish a Bluetooth connection based on the Bluetooth pairing information.

In some embodiments, the data transmission speed of the second communication mode is greater than the data transmission speed of the first communication mode. The first communication mode is used to transmit one or more items of network access information, file path information and instruction execution results of the target communication network. The second communication mode is used to transmit one or more items of file data and multimedia data.

In this embodiment, the communication connection established based on the first communication mode is more convenient. For example, when it is based on a serial port connection, it can be directly realized by plugging in the hardware structure. Exemplarily, the OPS module and the intelligent interactive UART interface, etc. The process is simpler. Further, based on the first communication mode, the first device and the second device can establish a second communication mode with faster data transmission speed. In this way, based on the second communication mode, various large files such as files and multimedia data (such as pictures and videos) can be transmitted faster.

In the technical solution of this embodiment, the data transmission speed and convenience are improved through the communication mode of two-way communication.

In some embodiments, the first device and the second device are located in the same local area network and connected through the local area network, and the second device is further configured to: send broadcast information to the local area network where it is located;
The first device is further configured to: send response information to the second device, wherein the response information is generated according to the broadcast information, and the response information carries device information of the first device;
The second device is further configured to: establish a communication connection with the first device according to the response information.

It can be understood that in this embodiment, the local area network refers to a regional network established in a local area, the distribution area of the local area network is limited, the data transmission speed inside the local area network is faster, the performance is more stable, the framework is simple, and it has a certain degree of closure. The second device may broadcast a specific message within the local area network where it is located. Exemplarily, the above broadcast information may be broadcast in a User Datagram Protocol (UDP) communication mode. The first device and the second device may access the same local area network in different ways such as the wired or wireless ways.

In some embodiments, when the second device establishes a communication connection with the first device according to the response information, it is specifically configured to:
add the first device to a device list according to the response information;
obtain a selection instruction for the first device;

Establish a communication connection with the first device according to the selection instruction.

In this embodiment, the first device and the second device can be two devices in the local area network. During implementation, the second device sends broadcast information, and multiple devices that receive the broadcast information can return response information, and the second device can add each device that returns the response information to the device list. Further, the first device among them is confirmed according to the user's selection, and a communication connection with the first device is established according to the device information carried in the response information returned by the first device to realize interaction between the first device and the second device and service sharing of applications, files, etc.

In some other embodiments, the first device and the second device may also establish a communication connection based on a wide area network, for example, the Internet.

In some embodiments, the display system further includes a management server, and the second device is further configured to: send a connection request to the management server;
The management server is configured to: send the device information of the first device to the second device according to the connection request, wherein the first device is pre-registered in the management server;
The second device is further configured to: establish a communication connection with the first device according to the device information.

In this embodiment, each device that can provide services is first registered in the management server. When the second device needs to establish a communication connection with the first device, the first device can be selected from the list of registered devices provided by the management server, and further establishes the communication connection with the first device based on the relevant information of the first device carried in the registration information.

It can be understood that when the first device and the second device are connected through a local area network or a wide area network, all interactive data such as command messages, file data, and instruction execution results between the first device and the second device are transmitted through the local area network or the wide area network.

In some embodiments, when the first device sends the application information of the first application program to the second device, it is specifically configured to:
Obtain application information of the first application program located in the target folder;
send the application information to the second device;
Wherein, the target folder is a folder with a preset path in the first device.

In this embodiment, the application program in the first device that the second device can invoke may be all application programs or some application programs. For example, the second device may access the register table information of the first device to invoke all application programs on the first device.

In some embodiments, in order to improve the convenience of device interaction, a specific target folder is set, and the second device can only call the application program in the target folder. The target folder may also be a folder with a preset path.

In some embodiments, the target folder may specifically be a desktop folder of the first device or a launch bar folder of the first device. In addition, it may also be a folder with a preset path such as a folder named a shared folder located on the desktop, so that the application sharing service provided by the first device can be controlled more conveniently.

In some embodiments, the first device is configured to:
Retrieve one or more of an application program of a preset program type, a file of a preset file type, and an application program with a preset name in the target folder as the first application program.

In this embodiment, after the target folder is determined, the first application program in the target folder is further determined. In this embodiment, one or more of an application program of a preset program type, a file of a preset file type, and an application program with a preset name are retrieved in the target folder as the first application program.

Exemplarily, in the case that the first device is an OPS module installed with the windows system, an application program with a preset name and an extension of “.exe” in the target folder may be retrieved as the first application program, or the application program with the preset program type of “executable application” or “application program” can be retrieved as the first application program, or a file with file type of “shortcut” or “shortcut launch method” can also be retrieved as the first application program.

In this embodiment, in order to improve the convenience of interaction between the first device and the second device, a file sharing function is also provided.

In some embodiments, the second device is further configured to:
Send a sharing request to the first device;
Receive the sharing information returned by the first device according to the sharing request, the sharing information includes a folder path and a sharing protocol of the shared folder, wherein the shared folder is a folder in the first device;
Access the shared folder according to the sharing protocol and the folder path.

During implementation, the file management function is first enabled in the second device, and then a file sharing request is sent to the first device. When the first device detects the file sharing request, the file sharing service is started, and the sharing information is returned to the second device, and the sharing information may carry relevant information such as an address of the shared space, a user name, and a password.

Based on the sharing information, the second device can access the folder path through the sharing protocol, so as to realize the access to the shared files in the shared folder, so as to access and operate the files in the second operating system based on the file sharing function.

The sharing request and sharing information can be transmitted based on the first communication mode or the second communication mode, and the files to be shared are transmitted through the second communication mode to increase the file transfer speed.

The sharing request and sharing information can be transmitted based on the first communication mode or the second communication mode, and the files to be shared are transmitted through the second communication mode to increase the file transmission speed.

In this embodiment, the sharing protocol can be an existing or improved file sharing protocol. Exemplarily, it can be based on File Transfer Protocol (ftp), sampa (a file sharing service), Network File System (nfs) and other modes for file sharing.

Exemplarily, a shared storage space may be provided through the above-mentioned ftp, samba or nfs protocol, and then the first device sends the sharing information of the shared space to the second device, so that the second device can access the shared space.

In some other embodiments, the file sharing function may be provided based on the second device.

In some embodiments, the second device is further configured to:
Generate a shared space;
Send space information of the shared space to the first device, wherein the space information includes a folder path and a sharing protocol of the shared space;
The first device is further configured to:
Send the shared file to the second device based on the sharing protocol and the folder path.

In this embodiment, a shared space is generated on the second device, for example, a shared folder may be established to share files in the shared folder.

Next, the space information of the shared space is generated. The space information needs to include at least the folder path of the space information. The first device communicatively connected with the second device can access the shared folder based on the folder path, so as to realize the file transmission to the shared folder or obtain file from the shared folder.

The space information may also include some other information, for example, may include the size, valid time of the shared folder, and the like.

After the space information is generated, then the space information of the shared folder is sent to the first device, and the first device can send the file to be shared to the shared folder based on the space information, or can obtain required files from the shared folder. In this way, the file is equivalent to a local file of the second device. At this time, the second device can directly call the file by calling the local device.

In this way, this embodiment realizes file sharing between the first device and the second device, and improves the interactive control effect between the first device and the second device.

As shown in FIG. 5, the technical solution of this embodiment can be summarized as follows. Firstly, the first device or the second device generates a shared space and enables the file sharing function, and then sends the space information of the shared space to another device, so that the other device can access the shared files in the shared space according to the space information to realize the file sharing function.

In addition, in some embodiments, the file sharing function can also be realized through the cloud server. Specifically, a file sharing space can be provided through the cloud server. During the working process, both the first device and the second device can upload files to the file sharing space and download files from the file sharing space. The file sharing between the first device and the second device is realized.

In some embodiments, file sharing can also be realized by hardware sharing. Specifically, the hardware structure is a data interface or memory. In this embodiment, the hardware structure is used as the data interface, and the data interface is specifically a USB interface.

In one embodiment, a USB interface is provided on the second device, and the USB interface has a switching configuration, which can be switched from hardware to be mounted on the board system of the first device or mounted on the board system of the second device. In this embodiment, a control switch can be set, and the circuit connection state of the USB interface can be controlled through the control switch, so that the USB interface can be mounted on the board system of the first device or mounted on the board system of the second device. During implementation, the files that need to be shared can be stored on mobile storage with USB interface such as U disk, mobile hard disk, and then the mobile storage is connected with the USB interface. When the file needs to be called in the first device, the switch control switch makes the USB interface to be mounted on the board system of the first device, so that the files in the mobile storage can be read based on the first operating system. Similarly, when the file needs to be called in the second device, the switch control switch makes the USB interface to be mounted on the board system of the second device.

When the hardware interface is a memory, its working principle is similar to the above process, and the mounting status of the memory can be controlled by setting the control switch, so as to realize the file sharing function.

An embodiment of the present disclosure also provides an electronic device, the electronic device is a second device in a display system, the display system includes a first device and a second device, the first device is installed with a first operating system, and the second device is installed with a second operating system, the second device includes a display, and the second device can control the display to display a display interface of the second operating system;
establishing a communication connection with the first device;
receiving application information of a first application program sent by the first device, wherein the first application program is an application program installed on the first operating system;
Displaying a first identifier on a display interface of the second operating system according to the application information of the first application program, wherein the first identifier is an identifier corresponding to the first application program. The first identifier sent by the second device is an identifier corresponding to the first application.

In some embodiments, the first device is an external computer module, the second device is an intelligent interactive tablet, and the intelligent interactive tablet includes a communication interface, and the external computer module communicates with the intelligent interactive tablet through the communication interface.

In some embodiments, the external computer module is an OPS module including an OPS interface.

In some embodiments, when the second device displays the first identifier on the display interface of the second operating system according to the application information, it is specifically configured to:
display a menu identifier on the first interface of the second operating system;
When an access request for the menu identifier is received, display a second interface including the first identifier.

In some embodiments, the first interface is a functional interface of handwriting software of the second operating system.

In some embodiments, when the second device displays the first identifier on the display interface of the second operating system according to the application information, it is specifically configured to:
Display at least one first identifier and at least one second identifier on a display interface of the second operating system, wherein the second identifier is an identifier corresponding to a second application program installed on the second operating system.

The electronic device in this embodiment is specifically the second device in the above display system embodiment, which will not be repeated here.

The embodiment of the present disclosure also provides an electronic device. The electronic device may be the first device or the second device. Referring to FIG. 8, the electronic device may include a processor 801, a memory 802, and a program 8021 stored in the memory 802 and executed by the processor 801.

In the case that the electronic device is the first device, the second device or the management server, when the program 8021 is executed by the processor 801, any steps in the above-mentioned method embodiments can be implemented and the same beneficial effect can be achieved, so details will not be repeated here.

Those skilled in the art can understand that all or part of the steps for implementing the methods of the above embodiments can be completed by program instructions related hardware, and the program can be stored in a readable medium.

Embodiments of the present disclosure also provide a readable storage medium, on which a computer program is stored. When the computer program is executed by a processor, any step in the above method embodiments can be realized, and the same technical effects are achieved, in order to avoid repetition, which will not be repeated here.

The storage medium is, for example, a read-only memory (ROM), a random access memory (RAM), a magnetic disk or an optical disk, and the like.

It should be noted that it should be understood that the division of the above modules is only a division of logical functions, and may be fully or partially integrated into a physical entity or physically separated during actual implementation. And these modules can all be implemented in the form of calling software through processing elements; they can also be implemented in the form of hardware; some modules can also be implemented in the form of calling software through processing elements, and some modules can be implemented in the form of hardware. For example, the determining module may be a separate processing element, or may be integrated in a chip of the above-mentioned device. In addition, it may be stored in the memory of the above-mentioned device in the form of program code, and a certain processing element of the above-mentioned device may call and execute the functions of the modules. The implementation of other modules is similar. In addition, all or part of these modules can be integrated together, and can also be implemented independently. The processing element mentioned here may be an integrated circuit with signal processing capability. In the implementation process, each step of the above method or each module can be completed by an integrated logic circuit of hardware in the processor element or an instruction in the form of software.

For example, each module, unit, subunit or submodule may be one or more integrated circuits configured to implement the above method, for example: one or more Application Specific Integrated Circuit (ASIC), or, one or more digital signal processor (DSP), or, one or more field programmable gate arrays (FPGA), etc. For another example, when one of the above modules is implemented in the form of a processing element scheduling program codes, the processing element may be a general-purpose processor, such as a central processing unit (CPU) or other processors that can call program codes. For another example, these modules can be integrated together and implemented in the form of a system-on-a-chip (SOC).

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A display control method, applied to a display system, wherein the display system comprises a first device and a second device, the first device is installed with a first operating system, and the second device is installed with a second operating system, the second device includes a display, and the second device controls the display to display a display interface of the second operating system;
the method comprises the steps of:
establishing, by the first device, a communication connection with the second device;
sending, by the first device, application information of a first application program to the second device, wherein the first application program is an application program installed on the first operating system;
displaying, by the second device, a first identifier on a display interface of the second operating system according to the application information, wherein the first identifier is an identifier corresponding to the first application program.

2. The method according to claim 1, wherein, after establishing, by the first device, a communication connection with the second device, the method further comprises:
sending, by the second device, a display request of the first application program to the first device;
the sending, by the first device, application information of a first application program to the second device, includes:
sending, by the first device, the application information of the first application program to the second device according to the display request.

3. The method according to claim 1, wherein the displaying, by the second device, a first identifier on a display interface of the second operating system according to the application information comprises:
displaying, by the second device, a menu identifier on a first interface of the second operating system;
when the second device receives an access request for the menu identifier, displaying a second interface including the first identifier.

4. The method according to claim 3, further comprising:
when the second device receives an initial access request for the menu identifier, determining whether the second device establishes communication connection with the first device,
if the second device has not established communication connection with the first device, establishing, by the second device, communication connection with the first device based on the initial access request.

5. (canceled)

6. The method according to claim 1, wherein the displaying, by the second device, a first identifier on a display interface of the second operating system according to the application information comprises:
displaying at least one first identifier and at least one second identifier on the display interface of the second operating system, wherein the second identifier is an identifier corresponding to the second application program installed on the second operating system.

7. The method according to claim 1, wherein after the displaying, by the second device, a first identifier on a display interface of the second operating system according to the application information, the method further include:
receiving, by the second device, an access request for a target application identifier in the first identifier;
sending, by the second device, a start request to the first device;
starting, by the first device, a target application program corresponding to the target application identifier according to the start request.

8. The method according to claim 7, wherein after starting, by the first device, a target application program according to the start request, the method further comprises:
switching the display of the second device to display the display interface of the first operating system;
running, by the first device, the target application program based on the first operating system, and displaying a running interface of the target application program on the display interface of the first operating system.

9. The method according to claim 7, wherein after starting, by the first device, a target application program according to the start request, the method further comprises:
generating, by the second device, an application window on the display interface of the second operating system, and the application window corresponding to at least part of an area of the display interface;
running, by the first device, the target application program, and sending an application running interface of the target application program to the second device;
displaying, by the second device, the application running interface in the application window;
wherein, after generating, by the second device, an application window on the display interface of the second operating system, the method further comprises:
receiving, by the second device, a first operation input for an area corresponding to the application window;
converting, by the second device, the first operation input into a second operation input corresponding to the first device;
sending, by the second device, the second operation input to the first device;
or
wherein, after the generating, by the second device, an application window on the display interface of the second operating system, the method further comprises:
receiving, by the second device, a first operation input for an area corresponding to the application window;
sending, by the second device, the first operation input to the first device;
converting, by the first device, the first operation input into a second operation input corresponding to the first device.

10.-11. (canceled)

12. The method according to claim 1, wherein the first device has a first communication module, the second device has a second communication module, the first device and the second device establishes communication connection in a first communication mode through the first communication module and the second communication module;
the first device and the second device establish communication connection in a second communication mode based on a target communication network;
a data transmission speed of the second communication mode is greater than a data transmission speed of the first communication mode.

13. The method according to claim 12, wherein, before the sending, by the first device, the application information of the first application program to the second device, the method further comprises:
when the first device and the second device are connected through the first communication mode, sending, by the second device, network access information to the first device through the first communication mode;
accessing, by the first device, the target communication network according to the network access information, wherein when the first device accesses the target communication network, the first device and the second device establish connection in the second communication mode based on the target communication network.

14. The method according to claim 13, wherein, before accessing, by the first device, the target communication network according to the network access information, the method further comprises:
detecting, by the first device, whether the first application program located in the target folder in the first device changes;
accessing, by the first device, the target communication network according to the network access information when the first application program located in the target folder changes;
or
wherein the second device includes a third communication module, the second device is in communication connection with the target communication network through the third communication module, and the network access information includes access information of the target communication network.

15. (canceled)

16. The method according to claim 12, wherein the second device includes a third communication module, and the target communication network is provided by the second device through the third communication module;
wherein the second device further comprises a fourth communication module, the fourth communication module comprises a wireless communication module and/or a network interface, and the second device establishes network connection through the wireless communication module and/or the network interface.

17. (canceled)

18. The method according to claim 12, wherein the first communication mode is serial port communication, and the second communication mode is wireless local area network data communication;
or
wherein the first communication mode is serial communication, and the second communication mode is Bluetooth communication;
or
wherein the first communication mode is used to transmit one or more of network access information, file path information and an instruction execution result of the target communication network;
the second communication mode is used to transmit one or more of file data and multimedia data.

19.-20. (canceled)

21. The method according to claim 1, wherein the first device and the second device are connected through a local area network, and before the first device sends the application information of the first application program to the second device, the method further includes:
sending, by the second device, broadcast information to the local area network where the second device is located;
sending, by the first device, response information to the second device, wherein the response information is generated according to the broadcast information, and the response information carries device information of the first device;
establishing, by the second device, communication connection with the first device according to the response information;
wherein the establishing, by the second device, communication connection with the first device according to the response information comprises:
adding, by the second device, the first device to a device list according to the response information;
obtaining, by the second device, a selection instruction for the first device;
establishing, by the second device, communication connection with the first device according to the selection instruction.

22. (canceled)

23. The method according to claim 1, wherein the display system further includes a management server, and before the first device sends the application information of the first application program to the second device, the method further includes:
sending, by the second device, a connection request to the management server;
sending, by the management server, the device information of the first device to the second device according to the connection request, wherein the first device is pre-registered in the management server;
establishing, by the second device, communication connection with the first device according to the device information.

24. The method according to claim 1, wherein the sending, by the first device, the application information of the first application program to the second device, comprises:
obtaining, by the first device, the application information of the first application program located in the target folder;
sending, by the first device, the application information to the second device;
wherein, the target folder is a folder with a preset path in the first device;
wherein the target folder is a desktop folder of the first device and/or a launch bar folder of the first device;
wherein, before the obtaining, by the first device, the application information of the first application program located in the target folder, the method further comprises:
retrieving, by the first device, one or more of an application program of a preset program type, a file of a preset file type, and an application program with a preset name in the target folder as the first application program.

25.-27. (canceled)

28. The method according to claim 1, further comprising:
sending, by the second device, a sharing request to the first device;
receiving, by the second device, sharing information returned by the first device according to the sharing request, wherein the sharing information includes a folder path and a sharing protocol of the shared folder, the shared folder is a folder in the first device;
accessing, by the second device, the shared folder according to the sharing protocol and the folder path;
or
the method further comprises:
generating, by the second device, a shared space;
sending, by the second device, space information of the shared space to the first device, wherein the space information includes a folder path and a sharing protocol of the shared space;
sending, by the first device, the shared file to the second device based on the sharing protocol and the folder path.

29. (canceled)

30. A display control method, applied to a first device in a display system, wherein the display system includes a first device and a second device, the first device is installed with a first operating system, and the second device is installed with a second operating system, the second device includes a display, and the second device controls the display to display a display interface of the second operating system;
the method comprises the steps of:
establishing communication connection with the second device,
sending the application information of the first application program to the second device, so that the second device displays a first identifier on the display interface of the second operating system according to the application information, wherein the first identifier is an identifier corresponding to the first application program, and the first application program is an application program installed on the first operating system.

31. A display control method, applied to a second device in a display system, wherein the display system includes a first device and a second device, the first device is installed with a first operating system, and the second device is installed with a second operating system, the second device includes a display, and the second device controls the display to display a display interface of the second operating system;
the method comprises the steps of:
establishing communication connection with the first device;
receiving application information of a first application program sent by the first device, wherein the first application program is an application program installed on the first operating system;
displaying a first identifier on the display interface of the second operating system according to the application information, wherein the first identifier is an identifier corresponding to the first application program.

32.-68. (canceled)

69. An electronic device, comprising: a memory, a processor, and a program stored on the memory and executed by the processor; the processor is used to read the program in the memory to implement the steps of the display control method according to claim 1.

70. (canceled)
